(19) United States
(12) Patent Application Publication
(10) Pub. No.: US 2006/0101517 A1
(43) Pub. Date: May 11, 2006

(54) Inventory management-based computer vulnerability resolution system

(76) Inventors: Carl E. Banzhof, Dallas, TX (US); Kevin Cook, Arlington, TX (US); David T. Helffrich, Plano, TX (US); Russell Chip Lawson, Dallas, TX (US)

Correspondence Address: CONLEY ROSE, P.C., 5700 GRANITE PARKWAY, SUITE 330, PLANO, TX, 75024, US

(21) Appl. No.: 10/975,828

(22) Filed: Oct. 28, 2004

(51) Int. Cl. G06F 11/00

(52) U.S. Cl. 726/25

(57) ABSTRACT

A remediation server, downloadable software and an associated method for protecting a computer network from vulnerabilities. Software in the form of at least one network protection module is downloaded to the remediation server for the computer network and executed to protect the computer network from vulnerabilities. Upon execution thereof, the network protection module queries a device inventory for the computer network which is maintained at the remediation server to determine if any devices of a specified device type reside on the computer network. For each such device determined to reside on the computer network, the network protection module subsequently resolves vulnerabilities for the device using a remediation signature associated with the device query.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The invention relates generally to remediated computer networks and, more particularly, to a computer vulnerability resolution system which utilizes inventory management processes to enhance remediation of vulnerable computer systems forming part of a computer network being remediated by the computer vulnerability resolution system.

### BACKGROUND OF THE INVENTION

Each year, computer systems face increasing numbers of vulnerabilities. For example, the Computer Security Institute reported 417 vulnerabilities for the year 1999, 1,090 vulnerabilities for the year 2000, 2,437 for the year 2001, 4,129 for the year 2002 and 3,784 for the year 2003. Not only has the reported number of vulnerabilities increased dramatically since 1999, the increasing number of computer systems which are interconnected with other computer systems in a computer network and the increasing complexity of such networks have made the task of protecting computer systems from such vulnerabilities increasingly difficult. For example, it has become quite difficult for a network security administrator to maintain an accurate inventory of hardware and, in particular, software devices residing on each computer system forming part of a computer network. Indeed, only minutes are needed for a user to download new software devices onto a computer system from the Internet. With each new piece of hardware or software added to a computer system, another potential vulnerability from which the computer network must be protected is created. However, the network security administrator may not even be aware of the need to remediate the computer network to address a newly discovered vulnerability in a particular piece of computer hardware or software if the network security administrator erroneously believes that the hardware or software is not installed within any of the computer systems forming the computer network.

Currently, many network security administrators use vulnerability scanning software or managed security providers to test individual computer systems of a computer network for security weaknesses. Typically, such tools generally provide detailed information on the vulnerabilities found in the computing environment of the tested computer systems, but provide limited means for correcting or resolving the detected vulnerabilities. In order for the network security administrator to remove the vulnerabilities, the network security administrator must typically expend a large amount of labor and resources to identify vulnerabilities. Additional labor is then required to install the vulnerability remediation or otherwise resolve the identified vulnerabilities on the computer systems identified by the scanning software as harboring the vulnerabilities. Oftentimes, this involves the network security administrator visiting each affected computer system and manually applying the necessary remediation thereto. In addition, once a remediation is applied to a computer system, a user can easily remove it or install additional software that invalidates the remediation, thereby wasting all of the effort expended during the initial installation of the vulnerability resolution.

U.S. Patent Publication No. 2003/0126472 to Banzhof, published Jul. 3, 2003, discloses an automated vulnerability resolution system in which a remediation database is constructed from an aggregation of vulnerability information for plural computer vulnerabilities. Remediation signatures to address these vulnerabilities are constructed for subsequent deployment to a client remediation server. Banzhof further discloses managed remediation techniques which include the selective deployment, by the client remediation server, of the remediation signatures to resolve vulnerabilities of computers coupled to the client remediation server. While Banzhof represents a significant improvement over prior techniques which required the manual remediation of vulnerable computer systems, the automated vulnerability resolution system disclosed in Banzhof requires significant control of the remediation process by the network security administrator operating the client remediation server. More specifically, while the network security administrator has been provided with a series of remediation signatures capable of resolving vulnerabilities within the network, the network security administrator was still responsible for a number of tasks, among them, importing vulnerability assessment data identifying security vulnerabilities found on computers or devices within the network and mapping the identified security vulnerabilities to selected remediation signatures.

It should be readily appreciated, therefore, that still further advancements in vulnerability resolution systems would be achieved if such systems were configured to provide the client remediation server responsible for remediating a computer network with device specific information which facilitates remediation of the computer network.

### SUMMARY

In one embodiment, the present invention is directed to a method for protecting a computer network from vulnerabilities by providing the computer network with at least one network protection module configured to (a) determine if one or more devices of a device type reside on the computer network and (b) remediate each of the one or more devices of the device type. In one aspect thereof, the network is protected from vulnerabilities by executing a first one of the at least one network protection modules. Upon execution thereof, the network protection module determines if any devices of the device type reside on the computer network and remediates each such device determined to reside on the computer network.

In another aspect of this embodiment of the invention, a device type and an inventory of devices which reside on the computer network are maintained in the network protection module and the computer network, respectively. In this aspect, the device type maintained in the network protection module and the device inventory maintained in the computer network are used to determine if devices of the device type reside on the computer network. In still another, a remediation signature is maintained in the network module and used to remediate each device of the device type determined to reside on the computer network.

In still another aspect of this embodiment of the invention, the computer network includes a remediation server. In this aspect, the network protection module is downloaded to the remediation server. In the alternative, the network protection module may be constructed from remediation signatures downloaded to the remediation server.

In another embodiment, the present invention is directed to a computer-readable media which tangibly embodies a set of instructions executable by a computer to perform a process for resolving vulnerabilities within a computer network. In this embodiment, the computer readable media is comprised of means for identifying devices which reside on the computer network and have a specified vulnerability and means for resolving the specified vulnerability for each of the identified devices. In one aspect thereof, the means for identifying devices having a specified vulnerability may be further comprised of means for identifying devices of a specified device type.

In still another aspect of this embodiment of the invention, the means for identifying devices having a specified vulnerability may be further comprised of means for establishing an association between the specified device type and the specified vulnerability. In another, the means for resolving the specified vulnerability for each of the identified devices may be further comprised of means for establishing an association between the specified vulnerability and a remediation signature and, in a further aspect thereof, the means for establishing an association between the specified vulnerability and a remediation signature for the specified vulnerability may be further comprised of means for establishing an association between the specified device type and the remediation signature.

In still another embodiment, the present invention is directed to software capable of protecting a computer network from at least one vulnerability. Variously, the software may include first, first and second or first, second and third software modules. The first software module determines if devices of a specified device type reside on the computer network and remediates all devices of the specified type determined to reside on the computer network. The second software module maintains an inventory of devices residing on the computer network. Finally, the third software module constructs the first software module by generating a query for devices of the specified device type and associating the generated query with a remediation signature.

In accordance with various further aspects of this embodiment, the first software module may determine if any devices of the specified device type reside on the computer network by querying the inventory of devices for a list of all devices of the specified device type which reside on the computer network and/or the third software module may reside on a computer system, remotely located relative to the computer network, which downloads the first software module to the computer network after construction thereof.

In still another embodiment, the present invention is directed to a remediation server comprised of a processor subsystem, a memory subsystem coupled to the processor subsystem and a set of instructions stored in the memory subsystem and executable by the processor subsystem. In this embodiment, the set of instructions remediates a plurality of computer systems coupled to the remediation server in a computer network by resolving at least one vulnerability of devices, residing on the plurality of computer systems, of at least one device type. In one aspect thereof, a device inventory containing a list of devices residing on the plurality of computer systems is stored in the memory subsystem. In another, the set of instructions is comprised of a query for devices of at least one device type. In this aspect, devices of the at least one device type which are contained in the device inventory are identified upon execution of the query. In another, the set of instructions further comprises a remediation signature associated with each one of the device types. In this aspect, the remediation signature resolves at least one vulnerability of devices of the device type associated therewith.

In an alternate aspect of this embodiment of the invention, the set of instructions instead comprises: (a) a query for devices of one or more device types; (b) one or more vulnerabilities associated with each of the one or more device types; and (c) a remediation signature associated with each one of the one or more vulnerabilities. In a further alternate aspect of this embodiment of the invention, a device inventory containing a list of devices residing on the plurality of computer systems is stored in the memory subsystem. In this aspect, execution of the set of instructions causes the query to identifies devices, of the one or more device types, that are contained in the device inventory while, in a still further aspect thereof, execution of the set of instructions resolves, for each device of the one or more device type, the one or more vulnerability associated with each of the one or more device type by application of the remediation signature associated with each of the one or more vulnerability to each device of the one or more device types.

Finally, in various further aspects of the foregoing, the set of instructions are downloaded to the remediation server.

### BRIEF DESCRIPTION OF THE DRAWINGS

FIG. 1 is a block diagram illustrating an automated vulnerability resolution system for remediating one or more computer systems and/or computer networks.

FIG. 2 is an expanded block diagram of a client remediation server and a computer system of the computer network of FIG. 1.

FIGS. 3A-B are a flow chart illustrating a method of remediating one or more computer systems and/or computer networks to protect the computer systems and/or computer networks from vulnerabilities.

FIG. 4 is a flow chart illustrating a method by which a client remediation server remediates a computer network associated therewith.

FIG. 5 is a flow chart of a method of acquiring an inventory database for the computer network of FIG. 1.

FIG. 6 is a flow chart of a method of constructing an action pack for remediating computer networks and/or systems such as the computer network of FIG. 1 and/or the computer system of FIG. 2

FIG. 7 is a flow chart of a method of remediating the computer system of FIG. 2 using the action pack constructed by the method of FIG. 6.

FIG. 8 illustrates a top layer of a drill down-type user interface from which remediation of the computer system of FIG. 2 may be initiated.

### NOTATION AND NOMENCLATURE

In the detailed description and claims which follow, certain terms are used to refer to particular system components. As one skilled in the art will appreciate, components may be referred to by different names. Accordingly, this document does not intend to distinguish between components that differ in name, but not function.

Also in the detailed description and claims which follow, the terms “including” and “comprising” are used in an open-ended fashion, and thus should be interpreted to mean “including, but not limited to . . . ”.

The term “couple” or “couples” is intended to mean either an indirect or direct electrical, wireline communicative, or wireless communicative connection. Thus, if a first device couples to a second device, that connection may be through a direct connection, or through an indirect connection via other devices and connections.

The term “vulnerability” generally refers to any hardware, software or firmware weakness or design deficiency that leaves a computer system open to assault, harm, or unauthorized exploitation, either externally or internally, thereby resulting in an unacceptable risk of information compromise, information alteration, or service denial.

The terms “remediate” and “remediation” generally refer to addressing or resolving vulnerabilities by taking a series of steps or actions to reduce or otherwise alleviate the security risk presented by the subject vulnerabilities.

The term “remediated computer network” generally refers to a computer network having one or more computer systems and a client remediation server which has performed at least one resolution of selected vulnerabilities for selected ones of the computer systems.

The term “remediated computer system” generally refers to a computer system for which at least one vulnerability thereof has been resolved by a client remediation server.

Definitions for certain other words and phrases may be provided throughout this patent document. Those of ordinary skill in the art should understand that in many, if not most instances, such definitions apply to prior, as well as future uses of such defined words and phrases.

### DETAILED DESCRIPTION

The detailed description which follows contains specific details intended to provide the reader with an understanding of how to practice the present invention. However, those skilled in the art will readily appreciate that the present invention may be practiced without such specific details. In other instances, well-known elements have been illustrated in schematic or block diagram form in order not to obscure the present invention in unnecessary detail. Additionally, some details have been omitted inasmuch as such details are not considered necessary to obtain a complete understanding of the present invention, and are considered to be within the understanding of persons of ordinary skill in the relevant art. It is further noted that, unless indicated otherwise, all functions described herein may be performed in either hardware, software, firmware, or a combination thereof.

Automated vulnerability resolution systems such as the automated vulnerability system to be more fully described below, have provided numerous benefits to network security administrators. More specifically, systems such as these have been able to enhance the protection of computer systems and networks by resolving vulnerabilities within the computer networks before the vulnerabilities have an opportunity to wreak havoc within the computer network, for example, when a fast-spreading computer virus causes any number of computer systems to crash. Examples of such automated vulnerability systems are disclosed in U.S. Patent Publication 2003/0126472 to Banzhof and U.S. patent application Ser. No. 10/810,927 to Banzhof et al. filed Mar. 25, 2004, both of which are hereby incorporated by reference as if reproduced in their entirety. The automated vulnerability resolution system hereinbelow described includes all of the features of the vulnerability resolution systems set forth in the above-referenced patent publication and patent application. In that the network security administrator is no longer necessarily tasked with the identification of devices or device groups for which vulnerabilities are to be remediated, the automated vulnerability resolution system set forth herein encompasses a number of enhancements over prior systems. More specifically, in contrast with the aforementioned prior systems and in accordance with aspects of the present invention, the network security administrator is provided with plural network protection modules, hereafter referred to as “action packs”, the execution of which will cause the action pack to seek out and resolve specified vulnerabilities for the various devices forming the computer network. To facilitate a description of these enhancements and to avoid unnecessary description of features common to both the current and prior automated vulnerability resolution systems, certain portions of the description of the common features have been omitted from the description which follows.

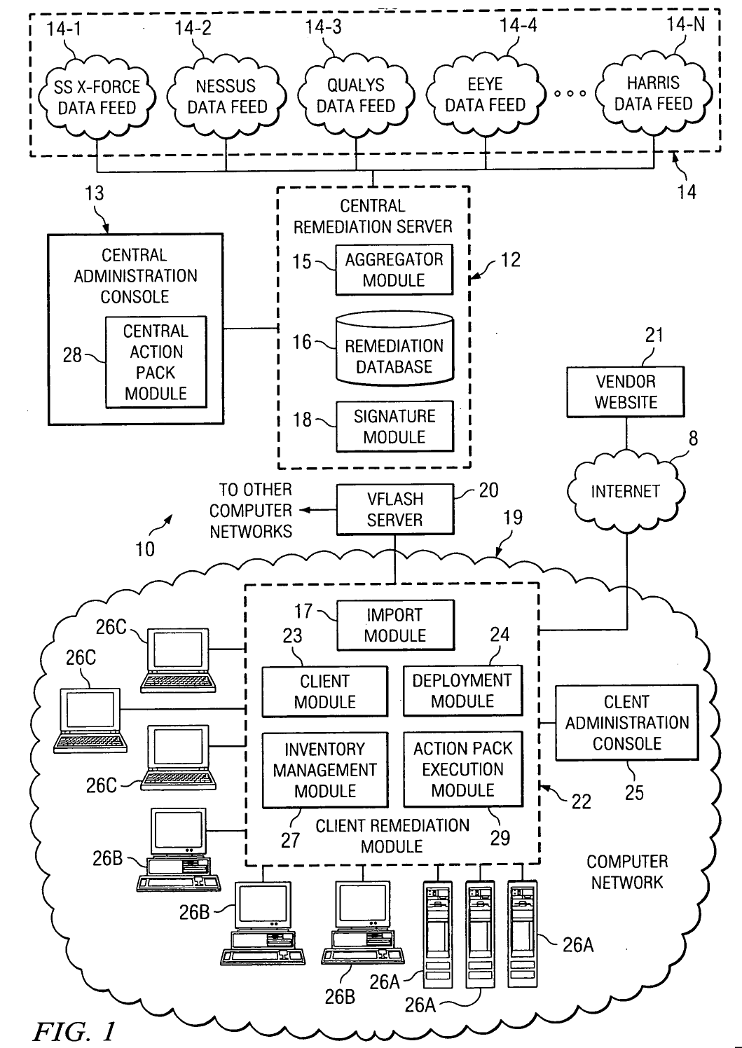

Referring first to FIG. 1, an automated vulnerability resolution system 10 will now be described in greater detail. As may now be seen, the vulnerability resolution system 10 comprises a central remediation server 12 coupled to a plurality of intelligence agents 14, one or more functional modules, including an aggregator module 15 and a signature module 18 and one or more databases, such as a remediation database 16, or other type of data store,

As used herein, the term “central” is not intended to infer or otherwise suggest any particular physical location of the central remediation server 12. Nor is the term intended to infer or otherwise suggest any particular level of control of the central remediation server 12 over other components of the vulnerability resolution system 10. Rather, as used herein, the term is merely used to distinguish the central remediation server 12, which: (1) aggregates vulnerability information; (2) constructs remediation signatures for subsequent download and use in resolving vulnerabilities; and (3) constructs, in conjunction with the central administration console 13, action packs for subsequent download and use in resolving vulnerabilities, from client remediation servers, for example, the client remediation server 22, which performs remediation on one or more computer systems using either: (1) vulnerability resolution information downloaded from the central remediation server 12; (2) action packs downloaded from the central remediation server 12; or (3) action packs constructed by the client remediation server 22 in conjunction with the client administration console 25 from vulnerability resolution information downloaded from the central remediation server 12.

Whether through the use of downloaded vulnerability entries containing remediation signatures or through the use of action packs, vulnerabilities which may be remediated by the automated vulnerability system 10 include five discrete classes of vulnerabilities—unsecured accounts, unnecessary services, backdoors, mis-configurations and software defects. Examples of unsecured accounts include accounts with no password, no password expiration and known vendor supplied passwords. Examples of unnecessary services which are found to reside on computer systems include Telnet, peer-to-peer services such as Kazaa, rsh, echo and chargen. Some of the more notorious backdoors or viruses creating or exploiting backdoors which have appeared on computer systems include MyDoom.A, W32.Beagle.I@mm, Netbus, Backorifice and Subseven. Common mis-configurations in computer systems include NetBIOS shares, Anonymous FTP world read/write and hosts.equiv. Finally, common software defects may include buffer overruns, RPC-DCOM and SQL Injection. Of course, it should be clearly understood that the specific types of vulnerabilities recited herein are purely exemplary and it is fully contemplated that automated vulnerability resolution system 10 may resolve a vast number of vulnerabilities other than those specifically recited herein. Furthermore, while five classes of vulnerabilities have been identified herein, it is fully contemplated that additional classes of vulnerabilities which have not been specifically identified herein may also be resolved by the automated vulnerability resolution system 10.

In the embodiment illustrated in FIG. 1, the disclosed functional modules, specifically, the aggregator module 15 and the signature module 18, as well as the remediation database 16, all reside within the central remediation server 12. For example, the aggregator module 15 and the signature module 18 may be embodied in software comprised of a series of lines of code stored in a memory subsystem (not shown) of the central remediation server 12 and executable by a memory subsystem (also not shown) of the central remediation server 12. The remediation database 16 consists of data stored at specified addresses within the memory subsystem and accessible by the processor subsystem, typically, using read or write operations. It is fully contemplated, however, that one or more of the aggregator module 15, the remediation database 16 and the signature module 18 may reside within one or more discrete devices coupled to the central remediation server 12. It is further contemplated that any such discrete devices within which the aggregator module 15, the remediation database 16 or the signature module 18 reside may either be locally or remotely located relative to the central remediation server 12. Finally, while each of the aggregator module 15 and the signature module 18 are described herein as discrete software modules, it is fully contemplated these modules may, in fact, collectively form a single software application.

A central administration console 13 is coupled to the central remediation server 12. In the embodiment disclosed herein, certain remediation functionality for the vulnerability resolution system 10 resides at the central administration console 13. More specifically, residing at the central administration console 13 is a central action pack module 28. The central action pack module 28 is comprised of a series of lines of code stored in a memory subsystem (not shown) of the central administration console 13 and executable by a processor subsystem (also not shown) thereof. As will be more fully described below, using the central action pack module 28, a vulnerability resolution system administrator may construct one or more action packs suitable for use in remediating computer systems. Briefly, an action pack is comprised of a set of one or more remediations, each of which have been associated with one or more vulnerabilities, each of which, in turn, has been associated with one or more devices. The term network protection module is used to refer to action packs specifically and, in some instances more inclusively to action packs in combination with various other elements of the vulnerability remediation system which use the action packs to remediate. The action pack is constructed, by the vulnerability resolution system administrator using information contained in the remediation database 16 or other data store.

While, in the embodiment disclosed herein, the central action pack module 28 is shown as residing at the central administration console 13, it is fully contemplated that, if desired, the central action pack module 28 may instead reside at the central remediation server 12, either as a discrete software module or as part of a common software application which also includes either the aggregator module 15, the signature module 18 or both.

As will be more fully described below, the central remediation server 12 provides remediation services to one or more computer networks, for example, computer network 19, coupled to the central remediation server 12 by a web server 20, for example, a VFLASH server. Of course, for ease of illustration, only one such computer network is shown in FIG. 1. If additional computer networks were to receive remediation services from the central remediation server 12, all such additional computer networks would also be coupled to the central remediation server 12 by the VFLASH server 20. However, several VFLASH servers would be necessary only when the demand for remediation services is sufficiently heavy that the additional computer networks can no longer timely download remediation signatures from the VFLASH server 20. Variously, it is contemplated that the computer network 19 may be a LAN, a wireless LAN (WLAN), a wide area network (WAN), a virtual private network (VPN), a wireless VPN (WVPN) or an internetwork, for example, the Internet or other combination of one or more LANs, WLANs, WANs, VPNs and/or WVPNs. Of course, the foregoing list is not intended to be exhaustive and it is fully contemplated that other types of computer networks or internetworks would be suitable for the purposes contemplated herein.

The computer network 19 is comprised of the client remediation server 22, an import module 17, a client module 23, a deployment module 24, an inventory management module 27, an action pack execution module 29, a client administration console 25 and plural computer systems, including, for example, one or more file servers 26A, one or more desktop computers 26B, for example, personal computers (PCs), and/or one or more portable computers 26C, for example, laptop, notebook or tablet computers. In the embodiment illustrated in FIG. 1, the import module 17, the client module 23, the deployment module 24, the inventory management module 27 and the action pack execution module 29 all reside within the client remediation server 22. For example, the import module 17, the client module 23, the deployment module 24, the inventory management module 27 and the action pack management module may each be comprised of a series of lines of code stored in a memory subsystem (not shown in FIG. 1) of the client remediation server 22 and executable by a processor subsystem (also not shown in FIG. 1) of the client remediation server 22. It is fully contemplated, however, that one or more of the import module 17, the client module 23, the deployment module 24, the inventory management module 27 and the action pack execution module 29 may reside within one or more discrete devices coupled to, the client remediation server 22. It is further contemplated that any such discrete devices within which the import module 17, the client module 23, the deployment module 18, the inventory management module 27 or the action pack execution module 29 resides may either be locally or remotely located relative to the client remediation server 22. For example, in one embodiment of the invention not shown in the drawings, it is contemplated that the action pack execution module 29 resides at the client administration console 25. Finally, while each of the import module 17, the client module 23, the deployment module 18, the inventory management module 27 and the action pack execution module 29 are described herein as discrete software modules, it is fully contemplated that plural ones of these discrete modules may, in fact, collectively form a common software application.

It should be clearly understood that the computer network 19 has been greatly simplified for ease of description. For example, in FIG. 1, various types of devices, for example, routers, switches, and printers, which typically form part of a computer network, have been omitted from the drawing for ease of illustration. FIG. 1 also shows the computer network 19 as including only a single client remediation server, specifically, the client remediation server 22. In this regard, it should be understood that, depending on the configuration of the computer network 19, additional client remediation servers may be required. Of course, when plural client remediation servers are required, each such client remediation server should be coupled to the client administration console 25 and to the VFLASH server 20 in a manner similar to that illustrated with respect to the client remediation server 22. Also, FIG. 1 shows each one of the file servers 26A, PCs 26B and portable computers 26C as being directly coupled to the client remediation server 22. However, depending on the particular configuration of the computer network 19, one or more of these devices may instead be indirectly coupled to the client remediation server 22, typically, through another network device. For example, each one of the PCs 26B may be coupled to the client remediation server 22 through one of the file servers 26A. Finally, the interconnections between the various ones of the network devices such as the file servers 26A, the PCs 26B and the portable computers 26C of the computer network 19 have also been omitted from FIG. 1 for ease of description.

The central remediation server 12 participates in the resolution of vulnerabilities in computer systems, for example, the file servers, PCs and portable computers 26A, 26B and 26C of the computer network 19, by providing resolution signatures suitable for use in resolving vulnerabilities, providing action packs configured to resolve selected vulnerabilities upon execution thereof and by providing a network security administrator or other IT or computer security professional responsible for maintaining network security with sufficient information to construct action packs suitable for use in resolving vulnerabilities in computer systems. To perform these functions, the central remediation server 12 must obtain information relating to computer security vulnerabilities from the intelligence agents 14. The aggregator module 15 provides the necessary interface between the central remediation server 12 and the various intelligence agents 14-1 through 14-N which maintain information relating to computer security vulnerabilities. Examples of commercially available intelligence agents which may serve as one of the intelligence agents 14-1 through 14-N may include: ISS X-Force, Nessus Scanner, Qualys QualysGuard Scanner, eEye Retina Digital Security Scanner, Harris STAT Scanner, ISS Internet Scanner, ISS System Scanner, Foundstone FoundScan Engine, Microsoft MBSA and others. The vulnerability information from the intelligence agents 14-1 through 14-N may come in many forms. Two such forms include: (1) general information from security intelligence organizations relating to known security vulnerabilities, such as vulnerabilities in widespread software applications like Microsoft Windows; and (2) specific information from scanning services such as those referenced hereinabove.

From whatever source received, the central remediation server 12 aggregates the obtained vulnerability information in the remediation database 16. While aggregating the vulnerability information into the remediation database 16, the central remediation server 12 may manipulate the information in various manners. For example, the central remediation server 12 may strip unnecessary portions of the acquired vulnerability information, sort the vulnerability information into related vulnerabilities, remove or duplicate selected vulnerability information and/or identify or otherwise establish associations between related vulnerabilities. Of course, the foregoing should not be considered to be an exhaustive list of the types of manipulation of vulnerability information which may be performed by the central remediation server 12 while aggregating acquired vulnerability information into the remediation database 16.

In addition, the central remediation server 12 uses the signature module 18 to generate remediation signatures for each one of the acquired vulnerabilities. Typically, a remediation signature is a list of actions which must be taken to address or otherwise resolve one or more vulnerabilities. As disclosed herein, the remediation signatures include the following types of remediation actions: service management, registry management, security permissions management, account management, policy management, audit management, file management, process management, as well as service pack, hot fix and patch installation. Each one of the foregoing types of remediation actions are generally known in the computer security industry and need not be herein described in further detail. Of course, it should be noted that the foregoing types are provided by way of example and it is fully contemplated that a remediation signature may encompass a wide variety of other types of remediation actions in addition to those specifically recited herein.

As previously set forth, a remediation signature may address one or more vulnerabilities. For clarity of description, however, it will hereafter be presumed that each remediation signature addresses a single vulnerability. Preferably, each remediation signature is constructed by the central remediation server 12 in the form of an abstract object which can be developed and implemented across multiple platforms without the need to change the underlying source code used by the central remediation server 12 to construct the signature. As a result, remediation signatures may be constructed by the central remediation server 12 and subsequently used in whatever system or environment that the client remediation server 22 is operating. The process of constructing a remediation signature may be an entirely automated process, a partially automated process having a limited degree of manual intervention required, a partially automated process requiring extensive manual intervention or an entirely manual process.

For example, in addition to the provided vulnerability information, some of the intelligence agents 14-1 through 14-N may also provide or suggest remediations for those vulnerabilities. In such situations, the process of constructing a remediation signature may be streamlined significantly, thereby reducing the needed level of manual intervention. Further, depending on the level of complexity of the vulnerability, a corresponding level of complexity may be required for the remediation signature. For example, some vendors provide “patches”, “fixes” or “updates” that address vulnerabilities in their hardware or software via their vendor website. A remediation signature may, therefore, include a link to a vendor website where a patch or update is available for download. Similarly, an action to be undertaken as part of a remediation of a vulnerability of a computer system may include the download of the patch or update identified in a remediation signature. It should be appreciated that, given the potential complexity of a remediation signature, remediation signatures may not always execute successfully upon completing the initial construction thereof. Accordingly, either the central remediation server 12 or a component thereof, for example, the signature module 18, should be further configured with the ability to test and approve a newly constructed remediation signature, thereby ensuring that the newly constructed remediation signatures successfully resolve the intended vulnerability and do not have any unintended deleterious effects.

Once a remediation signature has been constructed by the central remediation server 12, the remediation signature is assigned or otherwise associated with the corresponding vulnerability in the remediation database 16. Accordingly, the remediation database 16 may include vulnerability information and the corresponding remediation signatures for those vulnerabilities. Alternatively, it is contemplated that the remediation signatures could be stored elsewhere and remotely associated to the corresponding vulnerabilities using a pointer or other suitable association technique. For ease of description, an identified vulnerability and the remediation signature associated with that vulnerability shall hereafter be referred to as a vulnerability/remediation entry in which the identified vulnerability is contained in a first, or vulnerability, portion thereof and the remediation signature is contained in a second, or remediation, portion thereof.

The central remediation server 12 periodically posts newly constructed vulnerability/remediation entries, each comprised of an identified vulnerability and the associated remediation signature, to the VFLASH server 20 for dissemination to client computer networks such as the computer network 19 which receive remediation services from the central remediation server 12. Typically, newly constructed vulnerability/remediation entries will not be posted to the VFLASH server 20 until after the remediation signature contained therein has been tested and approved, by the central remediation server 12, for dissemination to clients seeking resolution of vulnerabilities in their computer systems or computer networks. Once uploaded to the VFLASH server 20 by the central remediation server 12, a client remediation server such as the client remediation server 22 can download the vulnerability/remediation entries from the VFLASH server 20. In this embodiment, a download is typically initiated by the network security administrator from the client administration console 25. Alternately, the network security administrator may schedule a download of the vulnerability/remediation entries to occur at a selected time or schedule recurring downloads at occur at selected times or intervals.

As previously set forth, the remediation database 16 contains therein any number of vulnerability/remediation entries, each comprised of a first portion containing an identified vulnerability and a second portion containing an associated remediation signature. Using the vulnerability/remediation entries contained in the remediation database 16, the vulnerability resolution system administrator may periodically elect to construct one or more action packs for subsequent use in remediating computer systems. As disclosed herein, the action packs are constructed using the central action pack module 28 and subsequently stored in the memory subsystem (not shown) of the central administration console 13. Of course, if desired, the action packs may be stored at other locations, for example, together with the vulnerability/remediation entries within the remediation database 16 or at a second data storage location (not shown) within the central remediation server 12.

In its broadest sense, an action pack is comprised of a device query and an action, typically, a remediation signature, associated with the action. To construct an action pack from the contents of the remediation database 16 or other storage location where the vulnerability/remediation entries are maintained, the vulnerability resolution system administrator must first construct a device query which identifies the device types to be remediated by execution of the action pack. To do so, the vulnerability resolution system administrator would first select a vulnerability/remediation entry from the plural vulnerability/remediation entries stored in the remediation database 16 or other storage location. While any of the vulnerability/remediation entries stored in the remediation database 16 may be selected, typically, the vulnerability resolution system administrator will select a newly constructed vulnerability/remediation entry which has either not yet been posted or has only recently been posted to be posted to the VFLASH server 20 for dissemination to client remediation servers such as the client remediation server 22.

The vulnerability portion of the vulnerability/remediation entry identifies the particular vulnerability identified in the vulnerability/remediation entry and the particular type of device which is susceptible to the vulnerability. Using this information, the vulnerability resolution system administrator constructs a device query which, when executed, will search an inventory data store for devices which match those type of devices identified as being susceptible to the identified vulnerability. Upon completing construction of the device query, the vulnerability resolution system administrator appends the remediation signature contained in the remediation signature portion of the vulnerability/remediation entry to the device query, thereby completing construction of an action pack. Upon completing the construction of one or more action packs in this manner, the vulnerability resolution system administrator posts the action packs to the VFLASH server 20, again for dissemination to client computer networks such as the computer network 19 which receive remediation services from the central remediation server 12. It should be noted, of course, that the foregoing is a highly simplified description of the construction of an action pack. Specifically, the foregoing description presumes that a single type of device will be susceptible to a particular vulnerability and that the action pack will address only that particular vulnerability for that particular type of device. It should be clearly understood, however, that, if desired, the action pack may be constructed such that execution of the action pack will resolve one or more vulnerabilities devices of one or more types.

In the described embodiment, the action pack effectively uses the results of a query for a device type or a specific characteristic of device type to determine whether or not to apply a given remediation signature (or set of remediation signatures). In another embodiment, where more than one remediation signature may address a given vulnerability, the action pack might query for device types or specific characteristics of device types to assess not only whether to apply a remediation signature, but also to select one of more than one possible remediation signatures to use to remediate the device to resolve a given vulnerability. For example, two different operating systems may have the same vulnerability, but different remediation signatures (defining different approaches to remediating the vulnerability) may be determined to have best effect for the different respective operating systems. Hence in querying for a device type (such as personal computer workstation) the action pack might further query for a device type of Windows, UNIX, or Mac, and the choose to apply a signature because the device is a workstation, and select which signature to apply based on the operating system.

Once uploaded to the VFLASH server 20 by the central remediation server 12, a client remediation server such as the client remediation server 22 can download the action packs and/or the vulnerability/remediation entries from the VFLASH server 20. In this embodiment, a download is initiated, from the client administration console 25 by the network security administrator. Alternately, the network security administrator may schedule a download of the action packs and/or vulnerability/remediation entries to occur at a selected time or schedule recurring downloads of the action packs and/or vulnerability/remediation entries at selected times or intervals. The client remediation server 22 may connect to the VFLASH server 20 in any number of ways such as establishing an Internet connection or establishing a direct dial-up connection. Further, as disclosed herein, the client module 23 provides the necessary interface logic for the download of information from the VFLASH server 20 to take place. Typically, the client remediation server 22 will periodically download information from the VFLASH server 20 as part of a check for new action packs and/or new or updated vulnerability and remediation information contained in vulnerability/remediation entries. The client remediation server 22 may also access vendor websites 21, via a global network such as the Internet or otherwise, to obtain additional patches or updates as needed for remediation. For example, if, during a subsequent execution of an action pack, the remediation signature analyzed and interpreted by the client remediation signature specifies a needed update or patch from a vendor website 21, the client remediation server 22 would connect to the website via a newly established Internet connection 8 and download the needed information making the patch or update available locally for remediation of appropriate ones of the client computers 26A, 26B and 26C coupled to the client remediation server 22.

It is further contemplated that the client remediation server 22 will maintain a profile of the computer systems 26A, 26B and 26C which rely on the client remediation server 22 for vulnerability resolution using the downloaded action packs and/or the remediation signatures contained in the downloaded vulnerability/remediation entries. Generally speaking, each of these profiles consists of a record or log of system information related to a respective one of the computer systems 26A, 26B and 26C. More specifically, the profile for any given one of the computer systems 26A, 26B and 26C will contain information related to remediations performed on that computer system 26A, 26B or 26C. It is contemplated, however, that the profile may also contain additional information related to the computer system 26A, 26B or 26C which would be helpful in managing security issues for that computer system. For example, the profile may contain information on the software applications and versions currently installed in the computer system 26A, 26B or 26C.

After the download thereof, the action packs may be executed by the network security administrator at any time. As will be more fully described below, upon execution of an action pack, the action pack will execute a device query, thereby locating, within the computer network 19, all of the devices capable of being remediated by the action pack. The action pack will then remediate the identified devices using the remediation signatures contained therein. In one aspect, it is contemplated that the network security administrator may simply execute newly received action packs upon receipt and rely upon the device query contained therein to identify the devices, residing within the computer network 19, requiring remediation. Alternately, it is contemplated that the network security administrator may utilize their personal familiarity with the computer network 19 to determine whether to execute an action pack or, if multiple action packs are downloaded to the client remediation server 22 and subsequently selected for execution, to determine in which order the action packs should be executed. Finally, it is contemplated that the network security administrator may first review the assets of the computer network 19, for example, by examining the profiles of the computer systems 26A, 26B, 26C forming the computer network 19 and/or risk data for the computer systems 26A, 26B, 26C and subsequently select one or more action packs for execution and, if appropriate, an order of execution of the selected action packs based upon the examination of the profiles and/or risk data for the computer systems 26A, 26B, 26C.

The profiles are also useful when remediating the computer network without the use of action packs or in conjunction with the use of action packs. More specifically, by comparing profiles for the computer system 26A, 26B or 26C with the remediation signatures contained in the vulnerability/remediation entries downloaded from the VFLASH server 20, the vulnerability information acquired by the client remediation server 22, for example, by scans of the computer systems 26A, 26B and 26C by a vulnerability assessment tool, and, if appropriate, the action packs which have already been executed and the vulnerabilities to have been resolved by those action packs, the client remediation server 22 will be able to determine which remediation or remediations are required for each computer system 26A, 26B, 26C of the computer network 19 to resolve identified vulnerabilities associated therewith, particularly, those which have not been resolved by execution of one or more action packs.

It is further contemplated that the profiles may be used as a tool to assist the client remediation server 22 managing the vulnerability resolution process for each computer system 26A, 26B, 26C of the computer network 19. For example, based upon an examination of the profiles, the client remediation server 22 itself, or the network security administrator accessing the client remediation server 22 via the client administration console 25, could select which action packs downloaded from the VFLASH server 20 should be deployed throughout the computer network 19 and/or which remediation signatures contained in vulnerability/remediation entries downloaded from the VFLASH server 20 should be deployed to each computer system 26A, 26B, 26C, and/or which vulnerabilities should or should not be addressed for each computer system 26A, 26B or 26C.

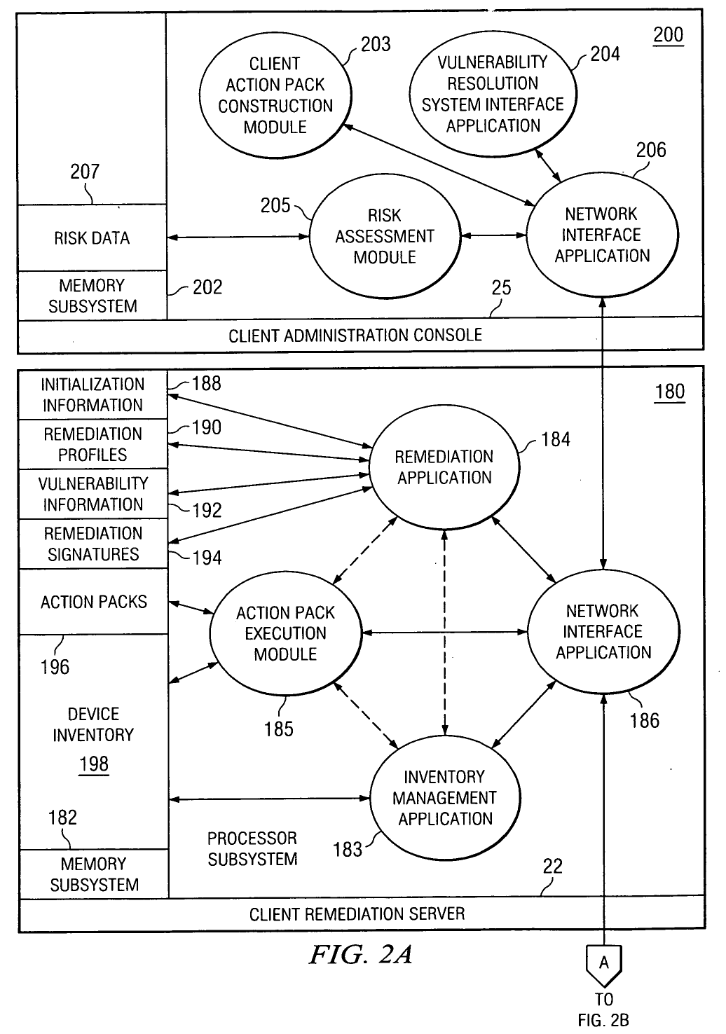

Another tool which provides useful assistance in managing the vulnerability resolution process and which may be use in conjunction with (or to the exclusion of) the profiles of the computer systems 26A, 26B or 26C is risk assessment software residing on the client administration console 25. Briefly, and as will be more fully described below, the risk assessment software, which appears in FIG. 2 as risk assessment module 205, assesses each computer system 26A, 26B, 26C of the computer network 19 and provides a risk factor for each. As used herein, the term “risk factor” represents a relative quantitative valuation of the exposure to financial harm or other adverse effects which could result from damage to or loss of the respective of the computer systems 26A, 26B, 26C. Of course, the type, number and severity of vulnerabilities identified for a computer system will be important considerations in determining the risk factor associated with that computer system. Other considerations used in determining the risk factor will have little to do with the vulnerabilities themselves. For example, greater risk may be associated with a particular computer system based upon the size or importance of the computer system and/or the specific software running on the computer system. For example, the financial exposure or other adverse effects resulting from the loss of a file server running mission critical software is greater than the financial exposure resulting from the loss of a PC used primarily for word processing.

By identifying those computer systems for which protection from vulnerabilities is most important, remediation management of the computer network which includes the identified computer system is enhanced. For example, the network security administrator may rearrange scheduling of the execution of plural action packs such that action packs configured to remediate higher valued computer systems execute before action packs configured to remediate computer systems of lesser value. Similarly, the network security administrator may rearrange the scheduling of plural action packs such that action packs configured to remediate vulnerabilities posing the greatest danger to computer systems execute before action packs configured to remediate vulnerabilities posing less danger.

Finally, vulnerability resolution can be still further managed by scheduling various other events less directly related to vulnerability resolution. For example, the network security administrator may schedule when and how often the computer systems 26A, 26B, 26C are scanned for vulnerabilities. The network security administrator may also time the deployment of remediation signatures to address the scanned vulnerabilities.

It is contemplated that, by managing vulnerability resolution through the selective deployment of action packs (which typically include device queries and remediation signatures) and/or remediation signatures alone, the remediation of vulnerabilities can be addressed with both greater reliability and cost effectiveness. In particular, it is contemplated that the deployment of action packs and/or remediation signatures can be scheduled to occur in off hours to minimize impact on the productivity of the computer systems 26A, 26B, 26C. The action packs and/or remediation signatures may also be selectively deployed or otherwise implemented. The remediations performed by the action packs and/or remediation signatures can be tracked and logged so that remediations are not accidentally overwritten or undone. The client remediation server 22 may execute the downloaded action packs or the remediation signatures contained in the downloaded vulnerability/remediation entries automatically, thereby eliminating any need to manually deploy the action packs and/or remediation signatures on each computer system 26A, 26B, 26C, a virtually impossible task for some large-scale companies. Finally, the use of action packs may eliminate or reduce the need for the network security administrator to associate remediations with the computer systems 26A, 26B, 26C on which the devices in need of remediation reside.

Referring next to FIG. 2, selected components of the computer network 19, more specifically, the client administration console 25, the client remediation server 22 and the portable computer system 26C may now be seen in greater detail. The portable computer 26C is illustrative of a computer system capable of being remediated to remove vulnerabilities therefrom by the download and subsequent execution of either action packs and/or remediation signatures contained in vulnerability/remediation entries by the client remediation server 22. In this regard, it should be noted that each of the other types of computer systems 26A and 26B of the computer network 19 are equally capable of being remediated will, therefore, have a number of similar components to those described and illustrated herein as residing within the portable computer system 26C. The client remediation server 22 serves as a repository for information needed to remediate the various computer systems 26A, 26B, 26C of the computer network 19. Finally, from the client administration console 25, the network security administrator may manage remediation of the computer network 19.

The portable computer 26C includes a processor subsystem 160, a memory subsystem 162, and a plurality of hardware devices 158-1 through 158-X, all coupled together by a bus subsystem (not shown). As disclosed herein, the processor subsystem 160 represents the collective processing functionality of the portable computer system 26C and may be distributed amongst any number of processing devices, including, for example, a central processing unit (CPU) and any number of secondary processing units. Similarly, the memory subsystem 162 represents the collective storage functionality of the portable computer system 26C and, like the processor subsystem 160, may be distributed amongst any number of memory devices including, for example, read only memory (ROM) and random access memory (RAM) devices. Finally, the bus subsystem represents the collection of buses residing within the portable computer system 26C and includes both the main system bus on which the hardware devices 158-1 through 158-X typically reside and all local buses.

Residing on the processor subsystem 160 are a remediation agent 163, plural local applications 164-1 through 164-X, a network protection initialization application 166, a network interface application 168, an inventory management application 169 and a firewall application 170. The remediation agent 163, the local applications 164-1 through 164-X, the network protection initialization application 166, the network interface application 168, the inventory management application 169 and the firewall application 170 are each comprised of a series of encoded instructions which reside in the memory subsystem 162 and are executable by the processor subsystem 160, typically using read or write operations. It is fully contemplated, however, that one or more of the remediation agent 163, the local applications 164-1 through 164-X, the network protection initialization application 166 or the inventory management application 169 may reside within one or more discrete devices coupled to the portable computer system 26C. Finally, while each of the remediation agent 163, the local applications 164-1 through 164-X, the network protection initialization application 166, the network interface application 168, the inventory management application 169 and the firewall application 170 are described herein as discrete software modules, it is fully contemplated that one or more of these modules may, in fact, collectively form a single software application.

Residing in the memory subsystem 162 are plural types of information. Each type of information may be stored at plural locations within the memory subsystem 162 which are associated with one another or, as illustrated in FIG. 2, the memory subsystem 162 may be subdivided into plural memory areas, each of which maintains a specified type of information. For example, FIG. 2 shows the memory subsystem 162 as including a memory area 172 in which initialization information is maintained, memory areas 174-1 through 174-X in which local application data is maintained for corresponding ones of the local applications 164-1 through 164-X and a memory area 176 in which a set of disconnected machine rules is maintained.

As previously set forth, the portable computer system 26C includes plural hardware devices 158-1 through 158-X coupled to the main system bus of the bus subsystem. It is contemplated that the hardware devices 158-1 through 158-X coupled to the main system bus of the portable computer system 26C may encompass a wide variety of devices including, for example, any of the various types of peripheral storage devices such as hard disks or tape drives; input, output or input/output (I/O) devices such as a keyboards, mouse, speakers, floppy drives, compact disk (CD) drives, digital video data (DVD) drives or printers; internal or external modems; or network interface cards (NICs). Of course, the foregoing hardware devices are listed purely by way of example and it is specifically contemplated that a wide variety of other types of hardware devices may comprise part of the hardware devices 158-1 through 158-X. As previously set forth, many, but not all, such hardware devices, couple to the main system bus of the portable computer system 26C and the number of devices which may be coupled to the main system bus of the portable computer system 26C is typically limited by the number of available connections to the main system bus. Such connections are often termed “slots”, particularly when used in connection with the physically larger computer systems, for example, PCs 26B or file servers 26A. Of course, the number of devices 158-1 through 158-X which may be coupled to the portable computer 26C may be substantially increased if the bus subsystem of the portable computer 26C is configured to include a universal serial bus (USB) to which any number of USB devices may be coupled.

Continuing to refer to FIG. 2, each of the applications residing on the processor subsystem 160 of the portable computer system 26C, more specifically, the remediation agent 163, the local applications 164-1 through 164-X, the network protection initialization application 166, the network interface application 168, the inventory management application 169 and the firewall application 170 will now be described in greater detail. The network protection initialization application 166 is responsible for maintaining, at the initialization information memory area 172, a unique remediated computer system identifier which identifies the portable computer system 26C and a unique client remediation server identifier which uniquely identifies the client remediation server 22. By periodically requesting these identifiers from the client remediation server 22, the network protection initialization application 166 is able to determine whether or not the portable computer system 26C is initialized and, if not initialized, to request initialization from the client remediation server 22. If initialized, the portable computer system 26C is capable of being remediated by the client remediation server 22. If not, however the portable computer system 26C cannot be remediated by the client remediation server 22.

The local applications 164-1 through 164-X are, as their name suggests, software applications local to the portable computer system 26C. In other words, the local applications 164-1 through 164-X are executed by the processor subsystem 160 and operate on data stored in the memory subsystem 162, typically, corresponding local application data memory areas 174-1 through 174-X. While it is contemplated that any number of local applications may reside in the portable computer system 26C, typically, the available space within the memory subsystem 162 will act to limit the number of local applications.

As will be more fully described later, in response to requests by inventory management application 183 of the client remediation server 22, the inventory management agent 169 collects information on each device residing on the computer system 26C. As used herein, the term “devices” refers to both hardware and software devices. It is contemplated, therefore, that the inventory management agent 169 would collect selected information on each of the hardware devices 158-1 through 158-X and each of the local applications 164-1 through 164-X. Accordingly, for purposes of illustration, FIG. 2 shows the inventory management agent 169 as being coupled to the local software application 168-2 and the hardware device 158-3 in connection with the collection of selected information therefrom. It should also be noted that the inventory management agent 169 may also collect information from one or more components which collectively comprise all or part of the processor subsystem 160 and/or from one or more components which collectively comprise the memory subsystem 162. Finally, it is contemplated that, if desired, the inventory management agent 163 may also collect information on the other applications residing on the processor subsystem 160, specifically, the remediation agent 163, the network protection initialization application 166, the network interface application 168 and the firewall application 170.

While the inventory management agent 163 collects information from a wide variety of devices forming part of the computer system 26C, for ease of description, only two such devices—the local software application 164-2, hereafter referred to as software device 164-2, and the hardware device 158-3 shall be discussed. It is contemplated that a wide variety of information may be respectively collected from the software device 164-2 and the hardware device 158-3. For example, information collected for a software device may include information such as software drivers, shared processes, dynamic linked libraries (DLLs) and other loading modules used thereby. Conversely, information collected for a hardware device may include, for example, type of device, memory address range, I/O address range and interrupt requests (IRQs) used. The collected information is arranged as a series of attributes, each associated with an identifier of the hardware or software device for which it was collected. In turn, the identifier for both hardware and software devices will include three components—device name, device group and device operating system (OS). At a minimum, the collected information will include an indicator of a device type for the identified hardware or software device and an internet protocol (IP) address or other locational information as to where, within the computer network 19, the identified hardware or software device may be found. Of the three components of the identifier of the hardware or software device, device name and device OS are self-explanatory. As used herein, device type may include some description of the hardware element or software element, the OS operating on the element, the release date or level or patch date or level, or some other characteristic or identification provided by a device group. Device group relates to the use of one or more characteristic shared by plural devices, typically, characteristics selected by the network security administrator, to organize devices into device groups. By appropriate exploitation of the organization of devices into device groups, vulnerabilities which affect plural types of devices may be more easily remediated. For example, if a vulnerability was identified for a family of software devices such as the Microsoft Office, the device group may be used to identify all of the software devices such as Word, Excel, PowerPoint, Outlook, FrontPage, PhotoDraw and Publisher which collectively form the Office family. From a hardware perspective device groups could be based on geography within the network architecture (i.e. inside or outside the primary firewall), the chips present in the hardware, the amount of ram, the type of I/O cards, or the role as servers as compared with personal computers. From a software perspective, device groups could be based on primary O/S compatibility, software suites (Microsoft Office, Lotus Smart Suite), groups of applications by function (security, data storage), or groups based on timing of the most recent software release, most recent patch release, and the like.

While a vulnerability may occur anywhere within the portable computer system 26C, most often, they appear within one of the local application 164-1 through 164-X or within one of the local application data memory areas 174-1 through 174-X which contains the data on which the corresponding one of the local applications 164-1 through 164-X operates. As will be more fully described below, such vulnerabilities are remediated by the remediation agent 163 using a remediation signature downloaded to the portable computer system 26C by the client remediation server 22, for example, upon either the execution of an action pack by the client remediation server 22 or upon distribution of a remediation signature contained in a vulnerability/remediation entry, again by the client remediation server 22.

The network interface application 168 provides the interface between the various applications, specifically, the remediation agent 163, the local applications 164-1 through 164-X, the network protection initialization application 166 and the inventory management agent 169, of the portable computer system 26C to the computer network 19. The firewall application 170, on the other hand, periodically serves as a barrier between the portable computer system 26C and the computer network 19, for example, when the portable computer system 26C seeks to re-connect with the computer network 19 after a period of disconnection. Accordingly, the remediation agent 163, the local applications 164-1 through 164-X, the network protection initialization application 166 and the inventory management agent 169 are all coupled to the network interface application which, in turn, is coupled to the firewall application 170.

The firewall application 170 works by limiting the flow of traffic between the network interface application 168 and the network interface applications of the various devices which collectively form the computer network 19, for example, a network interface application 186 of the client remediation server 22. The firewall application 170 is switchable between first and second states. In the first state, the firewall would be considered as being in a closed position in which traffic to and/or from the portable computer system 26C is limited while, in the second state, the firewall would be considered as being in an open condition in which traffic to and/or from the portable computer system 26C is unrestricted. Finally, when in the closed position, traffic between the portable computer system 26C and the client remediation server 22 is typically limited to (1) signals identifying the client remediation server 22 and/or the portable computer system 26C; and (2) signals containing remediation signatures.

The client remediation server 22 includes a processor subsystem 180 coupled to a memory subsystem 182 by a bus subsystem (not shown). As disclosed herein, the processor subsystem 180 represents the collective processing functionality of the client remediation server 22 and may be distributed amongst any number of processing devices including, for example, a CPU and any number of secondary processing units. Similarly, the memory subsystem 182 represents the collective storage functionality of the client remediation server 22 and, like the processor subsystem 180, may be distributed amongst any number of memory devices, for example, ROM and RAM devices. Finally, the bus subsystem represents the collection of buses residing within the client remediation server 22 and includes both the main system bus and all local buses.

Residing on the processor subsystem 180 are an inventory management application 183, a remediation application 184, an action pack execution module 185 and the network interface application 186. The inventory management application 183, the remediation application 184, the action pack execution module 185 and the network interface application 186 are each comprised of a series of encoded instructions which reside in the memory subsystem 182 and are executable by the processor subsystem 180, typically using read or write operations. It is fully contemplated, however, that one or more of the inventory management application 183, the remediation application 184 or the action pack execution module 185 may reside within one or more discrete devices coupled to the client remediation server 22. Finally, while each of the inventory management application 183, the remediation application 184, the action pack execution module 185 and the network interface application 186 are described herein as discrete software modules, it is fully contemplated that one or more of these modules may, in fact, collectively form a single software application.

Also residing in the memory subsystem 182 are plural types of information. Each type of information may be stored at plural locations within the memory subsystem 182 which are associated with one another or, as illustrated in FIG. 2, the memory subsystem 182 may be subdivided into plural memory areas, each of which maintains a specified type of information. For example, the memory subsystem 182 includes a first memory area 188 in which initialization information is maintained, a second memory area 190 in which remediation profiles are maintained, a third memory area 192 in which vulnerability information is maintained, a fourth memory area 194 in which remediation signatures are maintained, a fifth memory area 196 in which one or more action packs are maintained and a sixth memory area 198 in which a device inventory is maintained.

Each of the applications residing on the processor subsystem 180 of the client remediation server 22, more specifically, the inventory management application 183, the remediation application 184, the action pack execution module 185 and the network interface application 186 will now be described in greater detail. As will be more fully described below, the inventory management application 183 constructs an inventory of hardware and software devices residing on each of the plural computer systems 26A, 26B, 26C of the computer network 19. To do so, the inventory management application will periodically issue, to each computer system 26A, 26B, 26C of the computer network 19, a device inventory query instructing the inventory management agent residing on the queried computer system, for example, the inventory management agent 169 residing on the computer system 26C to acquire a list of hardware and software devices residing on the computer system 26C and to upload the acquired list to the client remediation server 22. Upon upload of the acquired list of hardware and software devices residing on the computer system 26C to the inventory management application 183, the uploaded list is stored in the device inventory memory area 198 of the memory subsystem 182. Variously, the uploaded information can be stored in a variety of formats. For example, the information may be arranged as a list of the types of devices found on each one of the various computer systems. Alternately, the information may be arranged as a list of the computer systems on which each one of various types of devices were found.

As illustrated in FIG. 2, the inventory management application 183 attends to the acquisition of the list of hardware and software devices. In the alternative, however, it is contemplated that the inventory management application 183 may instead, as indicated by the phantom line coupling the inventory management application 183 and the remediation application 184, issue a request to the remediation application 184 to acquire the desired list of hardware and software devices. In addition to acquiring inventory data on behalf of the inventory management application 183 (if appropriate), the remediation application 184 provides remediation signatures stored in the remediation signatures memory area 194 of the memory subsystem 182 to the remediation agent 163 in accordance with a first technique for resolving vulnerabilities for the portable computer system 26C. In contrast, the action pack execution module 185 provides remediation signatures stored in the action packs memory area 196, of the memory subsystem 182 to the remediation agent 163 in accordance with a second, improved, technique for resolving vulnerabilities in the portable computer system 26C.

The client administration console 25 includes a processor subsystem 200 coupled to a memory subsystem 202 by a subsystem bus (not shown). As disclosed herein, the processor subsystem 200 represents the collective processing functionality of the client administration console 25 and may be distributed amongst any number of processing devices including a CPU and any number of secondary processing units. Similarly, the memory subsystem 202 represents the collective storage functionality of the client administration console 25 and, like the processor subsystem 200, may be distributed amongst any number of memory devices including, for example, ROM and RAM devices. Finally, the bus subsystem represents the collection of buses residing within the client administration console 25 and includes both the main system bus and all local buses.

Residing on the processor subsystem 200 are a client action pack construction module 203, a vulnerability resolution system interface application 204, a risk assessment module 205 and a network interface application 206. The client action pack module 203, the vulnerability resolution system interface application 204, the risk assessment module 205 and the network interface application 206 are each comprised of a series of encoded instructions which reside in the memory subsystem 202 and are executable by the processor subsystem 200. It is fully contemplated, however, that one or more of the client action pack module 203, the vulnerability resolution system interface application 204 or the risk assessment module 205 may reside within one or more discrete devices coupled to the client administration console 25. Finally, while each of the client action pack module 203, the vulnerability resolution system interface application 204, the risk assessment module 205 and the network interface application 206 are described herein as discrete software modules, it is fully contemplated that one or more of these modules may, in fact, collectively form a single software application.

Residing on the memory subsystem 202 are one or more types of information. Each type of information may be stored at plural locations within the memory subsystem 202 or, as illustrated in FIG. 2, the memory subsystem 202 may be subdivided into one or more memory areas, each of which maintains a specified type of information. For example, FIG. 2 shows the memory subsystem 202 as including a memory area 207 in which risk data acquired by the risk assessment module 205 is maintained.

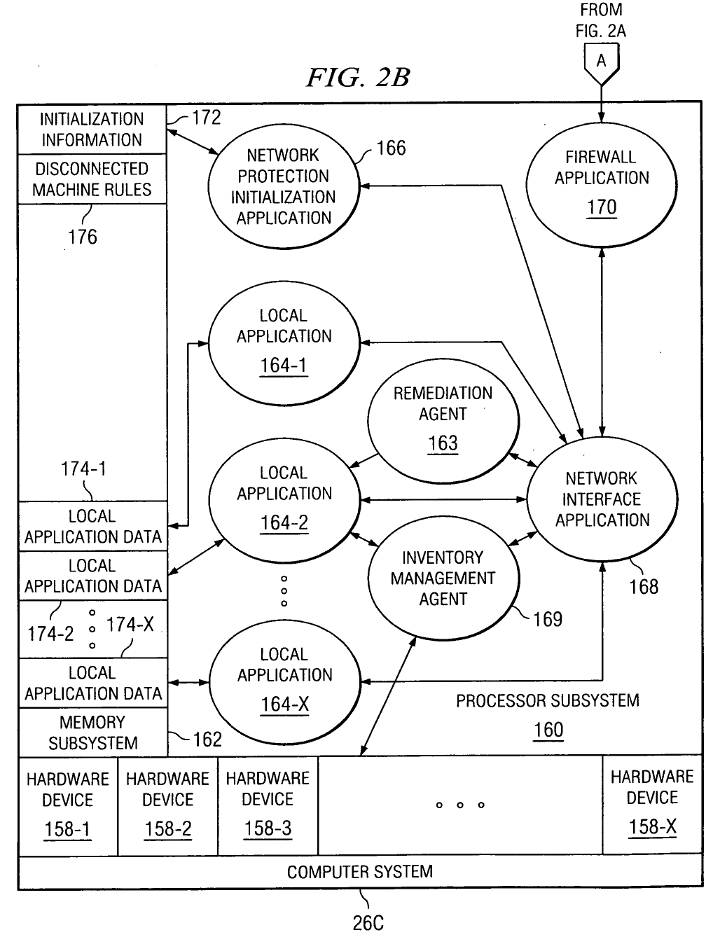

Referring next to FIGS. 3A-B, a method of remediating vulnerabilities in one or more computer systems and/or computer networks will now be described in greater detail. The remediation process illustrated in FIGS. 3A-B is comprised of two portions, a first portion 30A (FIG. 3A) executed at the central remediation server 12 and a second portion 30B (FIG. 3B) executed at the client remediation server 22. Of course, it should be clearly understood that the disclosed association of particular functionality with a specific one of either the central remediation server 12 or the client remediation server 22 is purely exemplary and it is fully contemplated that selected functionality may migrate downwardly from the central remediation server 12 to the client remediation server 22 or migrate upwardly from the client remediation server 22 to the central remediation server 12.

The first portion 30A of the remediation process commences at step 32 and, at step 34, the aggregator module 15 imports or otherwise aggregates information relating to computer security vulnerabilities, acquired from the intelligence agents 14, within the central remediation server 12, typically, within the remediation database 16. Continuing on to step 36, the signature module 18 of the central remediation server 12 may construct one or more new remediation signatures to address the vulnerabilities aggregated within the remediation database 16 and, at step 38, the constructed remediation signatures are approved for deployment to the VFLASH server 20. Of course, the remediation signatures, which, as previously noted, were constructed to remediate identified vulnerabilities, may be tested and revised before being approved for deployment. Upon approval of the remediation signatures, the method proceeds to step 40 for distribution of the remediation signatures to the client remediation server 22, for example, via the VFLASH server 20, for storage within the remediation signatures memory area 194 of the memory subsystem 182. Upon distributing the remediation signatures at step 40, the first portion 30A of the remediation process ends at step 42.

Referring next to FIG. 3B, the second portion 30B of the remediation process will now be described in greater detail. The second portion 30B of the remediation process, which, as previously set forth, is executed at the client remediation server 22, commences at step 44. At step 46, the vulnerability of the computer network 19 is assessed. As disclosed herein, vulnerability assessment encompasses a wide variety of processes and techniques employed using any number of tools including the use of automated assessment tools (not shown) to perform audit processes and the use of intelligence agents (not shown), residing within the computer network 19, to verify the existence of known vulnerabilities on each computer system 26A, 26B and 26C of the computer network 19 to receive remediation services from the client remediation server 22. Vulnerability assessment may also include device discovery; e.g., the mapping of network and subnetwork components to be assessed and identifying the devices that will be targeted for vulnerability assessment. Typically, vulnerability assessment is performed using one or more assessment tools and may include one or more intelligence agents, for example, the aforementioned ISS X-Force, Nessus Scanner, Qualys QualysGuard Scanner, eEye Retina Digital Security Scanner, Harris STAT Scanner, ISS Internet Scanner, ISS System Scanner, Foundstone FoundScan Engine and the Microsoft MBSA.

At step 48, the vulnerability information acquired by the intelligence agents of the computer network 19 is imported into the client remediation server 22 by the import module 17 for aggregation within the vulnerability information memory area 192 of the memory subsystem 182 of the client remediation server 22. Proceeding on to step 50, the vulnerability information (acquired by the intelligence agents of the computer network 19 and imported into the client remediation server 22 for storage in the vulnerability information memory area 192 of the memory subsystem 182) is associated with corresponding remediation signatures (contained in the vulnerability/remediation entries downloaded from the central remediation server 12 and stored in the remediation signatures memory area 194 of the memory subsystem 182) by a mapping process, typically performed by the remediation application 184.

Continuing on to step 52, the aggregated vulnerability information and associated remediation signatures are then reviewed by the network security administrator. Typically, the review process includes analyzing the vulnerability information to prioritize and identify vulnerabilities for remediation, as well as acceptable risks (i.e., where no remediation is required). At step 54, the network security administrator approves the remediation signatures for dissemination, by the remediation application 184, to targeted computer systems for execution on the targeted computer systems by the remediation agent 163. At step 56, the time, place and manner of the remediation is scheduled. By scheduling the remediation, it is possible for the network security administrator to ensure that the remediation occurs during off-peak times in which interference with normal computer operations would be minimized, is limited to a targeted group of computer systems identified as in need of remediation, or occurs in a desired manner.

Proceeding on to step 57, the scheduled remediations of the computer systems 26A, 26B and 26C of the computer network 19 are performed. To perform the remediations, the remediation application 184 residing at the client remediation server 22 delivers the appropriate remediation signature to a computer system, for example, the computer system 26C via the network interface application 186. There, the remediation signature is transferred, by the network interface application 168 to the remediation agent 165 for execution, thereby resolving the vulnerabilities of the computer system 26C. Upon completion of the scheduled remediation at step 57, the method proceeds to step 58 for review of the completed remediation. For example, status reports or other reporting tools may be used by the client remediation server 22 to determine if the scheduled remediation was successfully completed. In addition, remediation events may be logged or otherwise recorded to preserve information related to the completed remediation. Such information may be included in profiles for the computer systems 26A, 26B, 26C residing at the client remediation server 22 in the remediation profiles memory area 190 of the memory subsystem 182. As previously noted, such profiles may include information about the remediated computer systems such as system configuration, software, and prior remediation actions or a remediation history. Having such information allows for subsequent managed remediation of the computer systems 26A, 26B and 26C. After reviewing the completed remediation at step 58, the method ends at step 59.

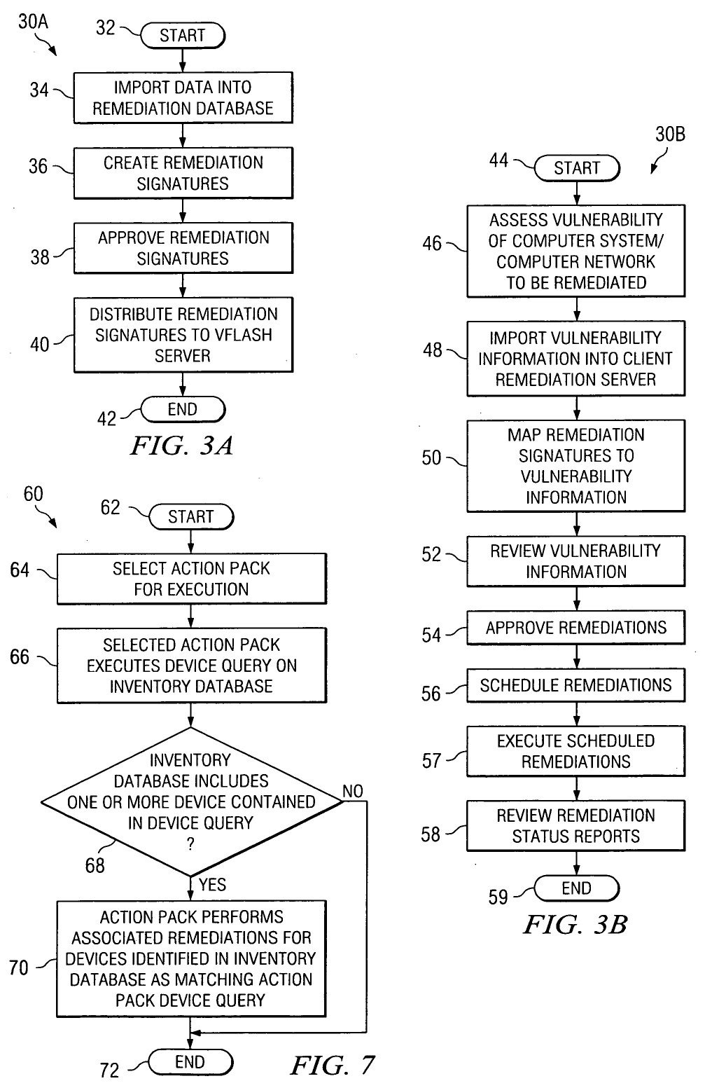

The remediation process described with respect to FIGS. 3A-B represents an overall description of a remediation process which includes vulnerability assessment, vulnerability remediation, and vulnerability management components. These components of the remediation process will now be described in greater detail with respect to FIG. 4.

FIG. 4 is a flow chart illustrating an embodiment of a remediation management process 60 for computer vulnerability remediation in accordance with the present invention. The remediation management process 60 is typically a software application, for example, the remediation application 184, installed on a client remediation server, for example, the client remediation server 22, which is coupled to a plurality of target computer systems, for example, the portable computers 26C, which may require remediation of security vulnerabilities. Accordingly, the process 60 begins at step 64 by launching the remediation application 184. Proceeding on to step 66, vulnerability entries containing available remediation signatures are downloaded, typically from a VFLASH server, for example, the VFLASH server 20, for storage in the remediation signatures memory area 194 of the memory subsystem 182. At step 68, vulnerability assessment data is imported for storage in the vulnerability information memory area 192 of the memory subsystem 182. Typically, this vulnerability assessment data comes from scanning tools which have scanned or analyzed the target computers for which remediation is being considered. The vulnerability assessment data includes information regarding the security vulnerabilities found on the target computers or devices. Based on the vulnerabilities identified on the target computers, the vulnerabilities are then mapped to remediation signatures at step 70. In this embodiment, mapping of the identified vulnerabilities to corresponding remediation signatures occurs by referencing the remediation database information downloaded from the VFLASH server 20. It is contemplated, however, that this information may have been previously downloaded, remotely accessed, or presently downloaded to make the necessary correlation between vulnerabilities and available signatures.

Continuing on to step 72, a remediation profile is then generated for each target computer system, for example, the portable computer system 26C, and stored in the remediation profiles memory area 190 of the memory subsystem 182. As noted, each remediation profile typically includes information regarding the vulnerabilities identified on the target computer system as well as the corresponding remediation signatures to address those vulnerabilities. At step 74, the network security administrator is given the opportunity to select which vulnerabilities should be remediated. Generally, the selection is made by reviewing the information regarding vulnerabilities, proposed remediation signatures, and profiles maintained in the remediation profiles memory area 190 of the memory subsystem 182. For example, the selection and review may be made by computer system or by vulnerability. For example, a particular computer system could be selected not to receive any remediation, perhaps because the computer system does not pose a significant security risk, the vulnerabilities on the computer system are not significant, the processes running on the computer system cannot be interrupted for remediation, etc. Alternatively, a particular vulnerability could be deselected for all target computer systems, such that the vulnerability would not be remediated on any of the target computer systems, perhaps because the vulnerability does not pose a sufficient security risk, the remediation signature is deemed too risky, etc. The review process could also include a compliance check in which target computer systems are checked for compliance with the proposed remediation. For example, while the remediation signature for a target computer system may include the installation of a patch, a compliance check may reveal that the patch is already installed on the target computer systems.

Once the network security administrator has selectively managed which vulnerabilities will be remediated by the remediation application 184, at step 76, the network security administrator can then select which computer systems will be approved to receive remediation. At step 78, the proposed remediation is analyzed to determine which remediation signatures will be required and, at step 80, the target computer systems that are to receive remediation are notified that a remediation is to occur. In the embodiment disclosed herein, the notification essentially comprises a message passed to the remediation agent 163 installed on each target computer system. Included in the remediation notification may be when the remediation is scheduled to occur. For instance, the remediation can be scheduled to occur at the instance of a particular event, such as a user logging off the machine, logging in, or any other action. In addition, the remediation may be scheduled to occur at a particular time. If desired, the remediation may be scheduled to occur at multiple times, thereby insuring that an important remediation is not inadvertently or maliciously removed during a subsequent usage of the target computer system. In either event, using the local clock of the target computer system, the remediation can be initiated at the scheduled time. Or alternatively, the remediation could occur as soon as the notification is received at the target computer system. Regardless of the triggering event, when the trigger is met the local remediation is launched at step 82.

Once the remediation is launched at step 82, the process 60 continues on to step 84 where the remediation profile for the target computer system is downloaded. Typically, the profile is downloaded from the client remediation server on which the client remediation management process application, typically, the remediation application 188, is running, i.e., the server that initially sent the notification of the pending remediation. The profile is then interpreted and the remediation signatures and actions specified in the profile are executed at step 86. The execution process could also include a compliance check for each signature to be executed, or even for each action in each signature, in which the target computer system is checked for compliance with the proposed remediation before actual execution of the remediation signature or action. For example, while the remediation signature for the target computer system may include the installation of a patch, a compliance check may reveal that the patch is already installed on the target computer system. This could also provide some additional benefit in that if, as discussed above, certain key remediations are rerun regularly to insure that they have not been undone by later activity on the target computer system, then the compliance check reduces the overhead addition of this activity since the remediation can stop at the compliance check if the previous work has not been undone. Continuing on to step 88, during remediation of the computer system 26c, the status of the remediation may be reported to the client remediation server 22 and monitored at the client administration console 25. In addition, the remediation steps may be prioritized and analyzed at step 90 to ensure the most efficient sequence of execution. At step 92, a reboot may be performed if needed for some of the remediation actions to take effect. Completion of the remediation on the target computer system, for example, the portable computer system 26C is then logged to the client remediation server 22 at step 94. Once remediation is completed, the method proceeds to step 96 for generation of one or more reports indicative of the effect of the remediation. Whether the remediation was successful or not is determined, at step 98, based upon the reporting generated at step 96. If the remediation is not deemed successful, either because it did not resolve the identified vulnerabilities as evidenced by an additional security scan of the target computer system, or because the remediation actions had unintended deleterious effects, etc., the process 60 will proceed on to steps 102 and 104 where the remediation can be rolled back or undone and repeated. The process would then return to an appropriate step, for example, step 82, the point at which the local remediation was launched.

Returning to step 98, if the remediation is deemed successful, for example, vulnerabilities are resolved and no deleterious effects are noticed, then the process 60 ends at step 100. In this manner, the new and updated remediation signatures made available to address or resolve identified vulnerabilities can be downloaded and used in an automated and managed remediation deployment to target computer systems.

Heretofore, applications of the remediation agent 163 and the remediation application 184 for the resolution of vulnerabilities in the computer systems 26A, 26B, 26C of the computer network 19 have been set forth in detail. It should be clearly understood, however, that the remediation agent 163 and the remediation application 184 may also be used for risk mitigation. For example, as part of the foregoing processes, a vulnerability in the portable computer 26C may be identified and mapped to a remediation signature. Rather than instructing the remediation agent 163 to resolve the vulnerability, however, the remediation agent 163 may instead be instructed to mitigate the risk posed to the computer network 19. For example, the virus or worm which forms the basis for the vulnerability may be structured to attack a specific port of the portable computer 26Cc. Rather than resolving the vulnerability by removing the virus or worm, the remediation agent 163 may instead be instructed to use the firewall application 170 to close off the port under attack, to filter for specific identified elements, to filter for actions from specific identified processes, or otherwise be employed to temporarily or permanently block key access or filter key areas to mitigate the identified risk until a more elegant solution may be obtained. By doing so, the risk to the computer network 19 may be quickly mitigated.

As one can appreciate from the foregoing description, remediation is a fairly complex process which requires a number of decisions by the network security administrator. Most important of these decisions involve the selection, at step 74, of which vulnerabilities are to be remediated. As noted above, the network security administrator typically selects the vulnerabilities to be remediated only after reviewing a variety of information, including vulnerabilities, proposed signatures, and profiles maintained in the remediation profile area 72. As a result, properly selecting a remediation remains a task best suited for experienced computer professionals who have become familiar with remediation techniques. Even for them, however, the proper selection of remediations may remain a daunting task.

Action packs are pre-constructed remediation packages suitable for execution by the client remediation server 22. As discussed elsewhere in the present disclosure action packs may be constructed by the remediation system provider or by the client, or in some cases they may be constructed by third parties to specifications an interfaces or API's provided by the remediation system provider to be distributed to clients. Action packs contain both a device query and a remediation signature. Unlike the remediation techniques hereinabove described, the network security administrator need only select an action pack for execution. Knowledge of the profile of a target computer, vulnerabilities of the target computer or remediation signatures for resolving the vulnerabilities of the target computer system is no longer required of the network security administrator. Once an action pack has been selected for execution, the action pack will identify those devices within the computer network which may be remediated using the remediation signatures contained therein. The action pack will then remediate the identified devices using the remediation profiles contained therein.

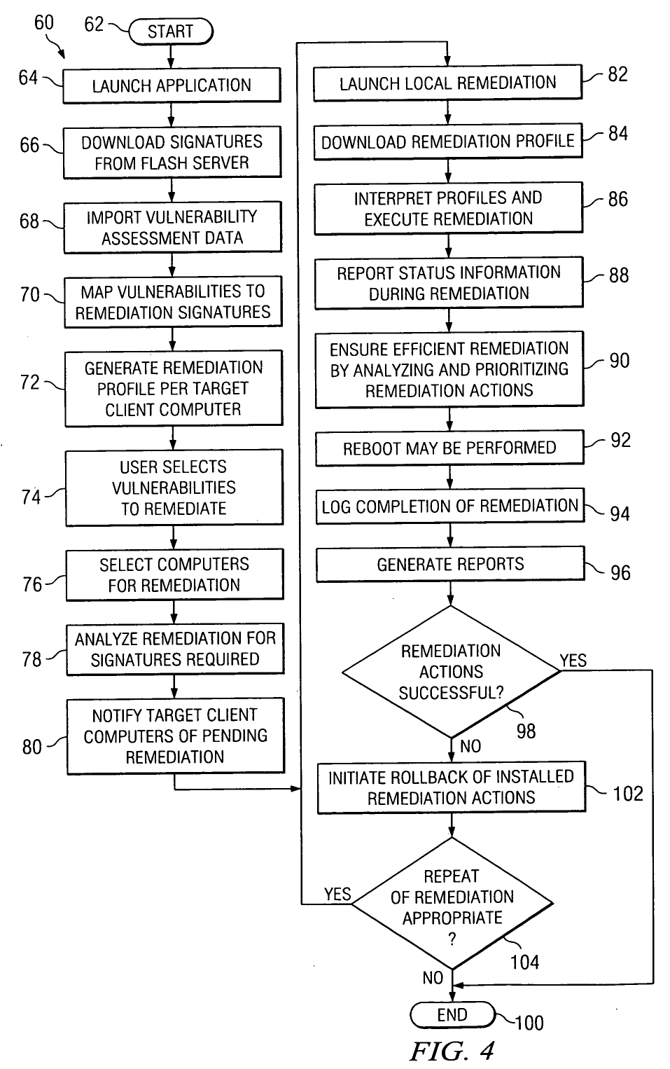

Before action packs may be selected for execution, however, certain preparatory steps must be performed. In a first preparatory action, a device inventory, for example, the device inventory stored in the device inventory memory area 198 of the memory subsystem 182 of the computer network 19 must be constructed. A method 110 suitable for use in constructing the device inventory 198 is illustrated in FIG. 5. In the embodiment disclosed herein, the method 110 by which the device inventory stored in the device inventory memory area 198 of the memory subsystem 182 is constructed is executed by the inventory management application 183. It is fully contemplated, however, that other techniques may be used to construct the device inventory 198. For example, each time that a computer 26A, 26B or 26C re-connects with the computer network 19, the re-connection process may include an upload of an inventory of the re-connecting computer system 26A, 26B or 26C.

The method 110 commences at step 112 and, at step 114, a first target computer system of the computer network 19 is selected. As used herein, each of the computer systems 26A, 26B and 26C would constitute a target computer system of the computer network 19. For example, a first one of the file servers 26A may be selected as the first target computer system of the computer network 19. It is fully contemplated, however, that computer systems other than those shown in FIG. 1 may also be target computer systems of the computer network 19. It should be noted that, in the embodiment illustrated in FIG. 1, the computer network 19 is comprised of the computer systems 26A, 26B, 26C. Accordingly, as described herein, the method 110 targets only computer systems. It should be clearly understood, however, that computer networks typically include a number a number of nodes, for example, routers and printers, which are not computer systems. Therefore, it is fully contemplated that the method 110 may also target devices other than computer systems.

Upon selecting the first target computer system of the computer network 119 at step 114, the method proceeds to step 116 for determination as to whether the target computer system contains at least one managed device. For example, the inventory management application 183 residing on the client remediation server 22 may issue a request, to the inventory management agent 163 residing on the target computer system, for example, the portable computer system 26C, for a list of managed devices residing on the target computer system. As used herein, a managed device includes all software and hardware which resides on the computer system, is at risk from any of the types of vulnerabilities described herein and is capable of being remediated. For example, a list of the managed devices for the portable computer 26C illustrated in FIG. 2 would be comprised of the processor subsystem 160, the memory subsystem 162, all of the applications, for example, the local applications 164-1 through 164-X, which are executed by the processor subsystem 160 and operate on respective data memory areas, for example, the data memory areas 174-1 through 174-X of the memory subsystem 162, and all of the hardware devices 158-1 through 158-X coupled to the bus subsystem. Of course, it is fully contemplated that alternate definitions of the term “managed devices” are suitable for the uses contemplated herein. It is also contemplated that use of an alternate definition for the term “managed devices” could potentially alter the list of managed devices for the target computer system of the computer network 19.

If, based upon the response received from the inventory management agent 169, it is determined that the target computer system of the computer network 19 has at least one managed device, the method proceeds to step 118 for selection of a first one of the at least one managed device and to step 120 for creation of a device entry, for the selected managed device, in the device inventory memory area 198 of the memory subsystem 182. In its most basic sense, the device entry in the device inventory memory area 198 is comprised of plural data fields containing information that, taken collectively, describe that device. As previously set forth, items of information that may be found in fields of a device entry include, among others, device name, device group, device OS and device location. Of course, it is fully contemplated that the different types of information will be collected for different types of device groups. For example, the types of information collected for a local application such as the local software application 164-2 will vary from the types of information collected for a hardware device such as the hardware device 158-3.

Upon creation of an entry, in the device inventory memory area 198 of the memory subsystem 182, corresponding to a first managed device residing on the first targeted computer system of the computer network 19, the method proceeds to step 122 for determination if the managed device for which the entry was created at step 120 is the last managed device residing on the target computer system. If it is determined at step 122 that there are additional managed devices for which entries need to be created, the method proceeds to step 124 for selection of a next managed device and then returns to step 120 for creation, in the device inventory memory area 198 of the memory subsystem 182, of an entry corresponding to the next managed device residing on the targeted computer system. Steps 120, 122 and 124 are then repeated until the device inventory memory area 198 of the memory subsystem 182 includes an entry for each managed device residing within the targeted computer system.

Returning to step 122, upon determining that the device inventory 198 includes an entry for each managed device residing within the targeted computer system of the computer network 19 or upon determining, at step 116, that the targeted computer system does not contain any managed devices, the method instead proceeds to step 126 for determination if the targeted computer system is the last computer system in the computer network to be inventoried. If, at step 126, it is determined that there are additional computer systems to be inventoried, for example, other file servers 26A, PCs 26B or portable computers 26C in the computer network 19 which have not yet been inventoried, the method proceeds to step 128 for selection of a next computer system to be targeted for inventory. The method 110 then returns to step 116 for further processing in the manner previously described. For each such iteration through steps 116, 118, 120, 122, 124, 126 and 128, an entry in the device inventory 198 is added for each device located at each targeted computer system of the computer network 19. Returning to step 126, upon determining that all of the computer systems in the computer network 19 has been successfully targeted and inventoried, construction of the device inventory 198, which is now comprised of an entry describing each device residing on each computer system 26A, 26B, 26C of the computer network 19, is complete and the method 110 ends at step 129.

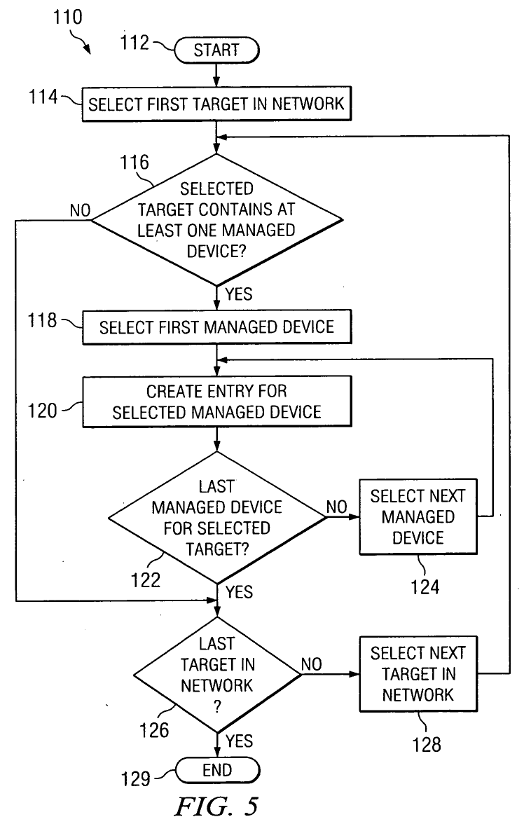

A second preparatory action which must be performed before the computer network 19 can be remediated by executing one or more action packs, is that the action packs themselves must be constructed. A method 130 for constructing an action pack, for example, one of the action packs stored in the action pack memory area 196 of the memory subsystem 182, will now be described with respect to FIG. 6. Of course, the method 130 must be repeated for each action pack to be constructed. Further, as described herein, the vulnerability resolution administration constructs one or more action packs by executing the central action pack construction module 28 residing at the central administration console 13. As will be more fully described below, while constructing the action packs, the central action pack construction module 28 must acquire certain information related to any number of vulnerabilities and the corresponding remediation information for the vulnerability As previously set forth, the foregoing information is maintained in the remediation database 16 located within the central remediation server 12. Accordingly, in one embodiment, it is contemplated that the central action pack construction module 28 access the remediation database 16 to acquire the requisite information.

Of course, it should be clearly understood that the action packs may be constructed from various locations and/or using a variety of techniques. For example, in accordance with the method 130 described herein, the action packs are constructed by the network security administrator by executing the central action pack construction module 28 residing at the central administration console 13. As it is contemplated that the client action pack construction module 203 is similarly configured to the central action pack construction module 28, the method 130 of constructing an action pack at the central administration console 13 is equally applicable to the construction of an action pack at the client administration console 25. Here, however, the central action pack construction module 28 would instead access the remediation signatures maintained in the remediation signatures memory area 194 of the memory subsystem 182 to acquire needed information related to any number of vulnerabilities and the remediation signature for each such vulnerability.

The method 130 of constructing an action pack commences at step 132 and, at step 134, a device query which, when executed, will identify the devices to be remediated by the action pack under construction, is created. As disclosed herein, a device query is, in essence, a device search capable of identifying both hardware and software devices, either by name, by attribute, or, most commonly, by a combination of name and one or more attributes. More specifically, the device query is constructed of a “find” command in combination with the name or other attribute to be searched. Purely by way of example, “Find (Windows XP Devices With Outlook)”, “Find (Red Hat Devices)”, “Find (All Devices With Less Than 500 Megabytes of Memory)” and “Find (All Intelligent Devices)” are relatively simple device queries which may be constructed at step 134. Of course, as the foregoing device queries appear in text form for ease of comprehension, the actual device queries constructed at step 134 would differ somewhat in appearance from the device queries set forth herein. Further by way of example, a more complex device query which may be constructed at step 134 is “Find (Device Group: ‘Group 1’ AND Netbios Name: LIKE ‘DEV*” OR Operating System: LIKE ‘Windows*”). While the foregoing more accurately represents the actual physical structure of a device query, for ease of comprehension, it, too, partially appears in text form.

While it is contemplated that the vulnerability resolution administrator may construct the device query such that any desired device type or types may be the subject of the query, as previously set forth, device types identified in recent vulnerability entries are commonly selected as subjects of a device query being constructed. Having created a device query which identifies the device types for which the action pack will search for upon execution, the method proceeds on to step 136 where the vulnerability resolution administrator selects a first device type included in the device query for further study and to step 138 where the vulnerability resolution administrator determines if the selected device type has any identified vulnerabilities.

To determine if the device type has any identified vulnerabilities, the vulnerability resolution administrator would review the contents of the remediation database 16, which, as previously set forth, contains plural vulnerability entries, each comprised of a first portion in which both a particular vulnerability and the particular types of devices susceptible to the particular vulnerability are contained and a second portion which contains a remediation signature for the particular vulnerability. If a review of the remediation database 16 reveals one or more vulnerabilities associated with the selected device type, the method proceeds to step 140 where the identified vulnerabilities are associated with the selected device type.

Upon association of the identified vulnerabilities with the selected device type at step 140 or upon determining, at step 138, that the selected device type does not have any identified vulnerabilities, the method proceeds to step 142 for determination if the selected device type is the last device type in the device query. If the device query contains additional device types with which one or more vulnerabilities may potentially be associated therewith, the method proceeds to step 144 for selection of a next device type included in the device query. The method then returns to step 138 where the identification of vulnerabilities to be associated with the next selected device type proceeds in the manner previously set forth.

Returning to step 142, upon identifying, from a review of the contents of the remediation database 16, the vulnerabilities for each device type contained in the device query and upon associating each identified vulnerability with the corresponding one of the device types contained in the device query, the method proceeds to step 146 for selection of a first vulnerability of the identified vulnerabilities which have been associated with one or more of the device types contained in the device query. Continuing on to step 148, a remediation of the selected vulnerability is identified from the contents of the remediation database 16 and associated with the selected vulnerability. For example, as previously set forth, each vulnerability entry in the remediation database 16 contains a vulnerability portion and a remediation portion. Thus, matching the selected vulnerability to a vulnerability entry in the remediation database 16, enables the vulnerability resolution administrator to identify the remediation corresponding to the selected vulnerability.

Upon associating the identified remediation corresponding to the selected vulnerability, the method proceeds to step 150 where it is determined if remediations have been associated with all of the vulnerabilities associated with one or more device types included in the device query. If it is determined at step 150 that there are additional vulnerabilities to which remediations have not yet been associated, the method proceeds to step 152 for selection of a next vulnerability associated with one or more device types included in the device query. The method then returns to step 146 for selection of a next vulnerability associated with one or more device types included in the device query and for which one or more remediations are to be associated therewith.

Returning now to step 150, upon associating one or more remediations with each of the vulnerabilities associated with one or more of the device types included in the device query, construction of the action pack is complete and the method will end at step 154.

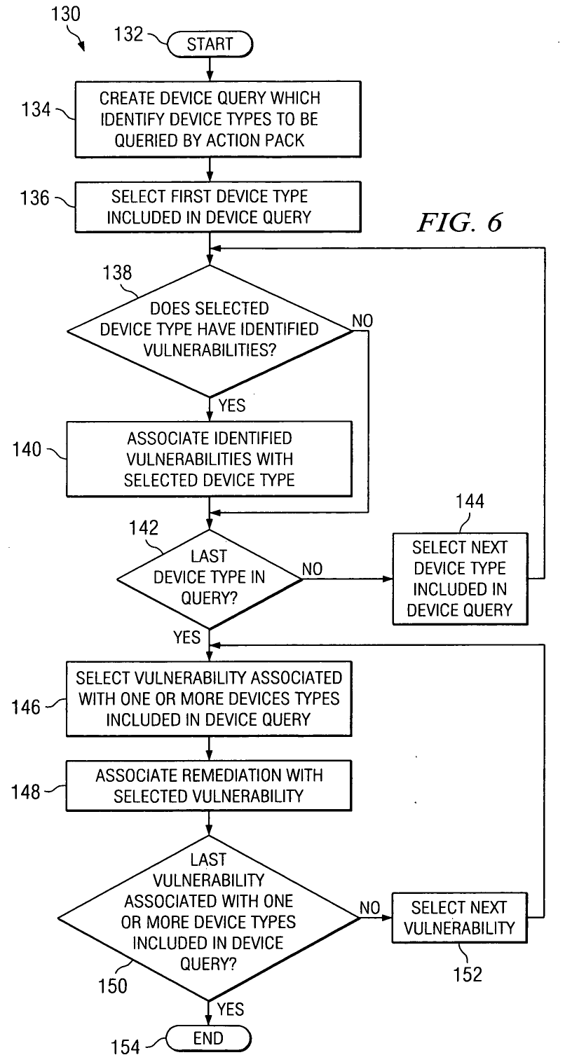

Referring next to FIG. 7, a method 160 of remediating the computer network 19 using one or more action packs constructed in accordance with the method 130 illustrated in FIG. 6 will now be described in greater detail. As previously set forth, action packs may be constructed by the vulnerability resolution administrator using the central action pack module 28 residing on the central administration console 13 or by the network security administrator using the client action pack construction module 203 residing on the client administration console 25. Whether constructed at the central administration console 13 and downloaded to the client remediation server 22 via the VFlash server 20 or constructed by the client action pack construction module 203, the action packs are stored at the action pack memory location 196 of the memory subsystem 182 where they can be selected, by the network security administrator, for execution at any time.

The method 160 commences at step 162 with the network administrator being advised of the action packs stored at the memory location 196 and ready for execution. For example, it is contemplated that, upon accessing the client remediation server 22, a display which includes a list of the action packs available for execution may be generated by the vulnerability resolution system interface application 204. Proceeding on to step 164, the network administrator would then select one or more action packs for execution, the time at which the selected action packs are to be executed and, if multiple action packs are selected, the order of execution. Selection of which action packs are to be executed may be based on a variety of factors. One such factor would be the personal knowledge of the computer network 19 by the network security administrator. For example, the listing of available action packs may each include a brief description of the type of device at risk from the vulnerability. Based upon these descriptions, the network administrator may be able to determine which action pack addresses the vulnerability posing the greatest risk to the computer network 19. The network administrator would then select the action pack which would have the greatest impact in protecting the computer network 19.

Another factor which may be used in selecting either which action packs are to be executed, the time of execution and/or the order of execution may involve a quantitative assessment, by the network administrator, of the risk posed to the computer network 19 by the vulnerabilities to be remediated by each action pack. To quantitatively assess the risks posed to the computer network 19, the network administrator would execute the risk assessment module 205 which, as previously set forth, accesses risk data 207 to determine a risk factor for each computer system 26A, 26B, 26C of the computer network 19. By reviewing both the risk factor for each of the various computer systems 26A, 26B, 26C and the available action packs, the network administrator may recognize that certain of the action packs address vulnerabilities which place the computer network 19 at a greater overall risk. The network administrator would then select the action packs to be executed, the time of execution and/or the order of execution to address the greatest risks to the network first.

Upon the network administrator selecting an action pack for execution at step 164, typically, by issuing an execution instruction to the vulnerability resolution system interface application 204 which, in turn, would issue an execution instruction to the action pack execution module 185, the method proceeds to step 166 where the action pack execution module 185 would first retrieve the selected action pack and begin execution of the instructions contained therein. More specifically, the selected action pack would first execute a device query on the device inventory 198 which, as previously set forth, contains an inventory of the devices residing on all of the computer systems 26A, 26B, 26C of the computer network 19. Variously, the action pack execution module 185 may review the contents of the device inventory memory area 198 of the memory subsystem 182 itself or, as shown in phantom in FIG. 2, the action pack execution module 185 may instruct the inventory management application 183 to: (1) conduct a device query on the device inventory 198; and (2) report back with the results of the device query.

As previously set forth, the device query is a search for a device or devices specified within the query. During the device query, the action pack execution module 185 (or the inventory management application 183 acting on behalf of the action pack execution module 185) compares each device listed in the device inventory 198 to the device types identified in the device query and determines if the computer network 19 includes any devices of the device types identified in the device query. Upon execution of the device query at step 166, the method proceeds to step 168 for a determination as to whether the device inventory 198 indicates that one or more devices of the device types identified in the device query reside in the computer network 19. If so, a list of the devices is compiled and the method continues on to step 170 where each device residing in the computer network 19 which matches one of the device types listed in the device query is remediate to remove the vulnerability associated with that particular device type.

As previously set forth, the action pack is comprised of a device query comprised of one or more device types and a corresponding number of remediation signatures, each associated with one of the device types. For each device residing in the computer network 19 which is identified as being of a device type contained in the device query, the remediation signature is then used to remediate the device. To do so, the remediation signature associated with a device type is downloaded to each device in the computer network 19 of that device type. The download may be performed by the action pack execution module 185 itself or, as shown in phantom in FIG. 2, may be performed, on behalf of the action pack execution module 185, by the remediation application 184. The action pack execution module 185 (or the remediation application 184 acting on behalf of the action pack execution module 185) downloads the corresponding remediation signature to the remediation agent 163 residing on the same computer system, for example, the portable computer 26C, on which the device matching the device type corresponding to the downloaded remediation signature. Using the remediation signature received thereby, the remediation agent 163 remediates the vulnerability on the device. For example, FIG. 2 shows the remediation agent 163 remediating the local application 164-2.

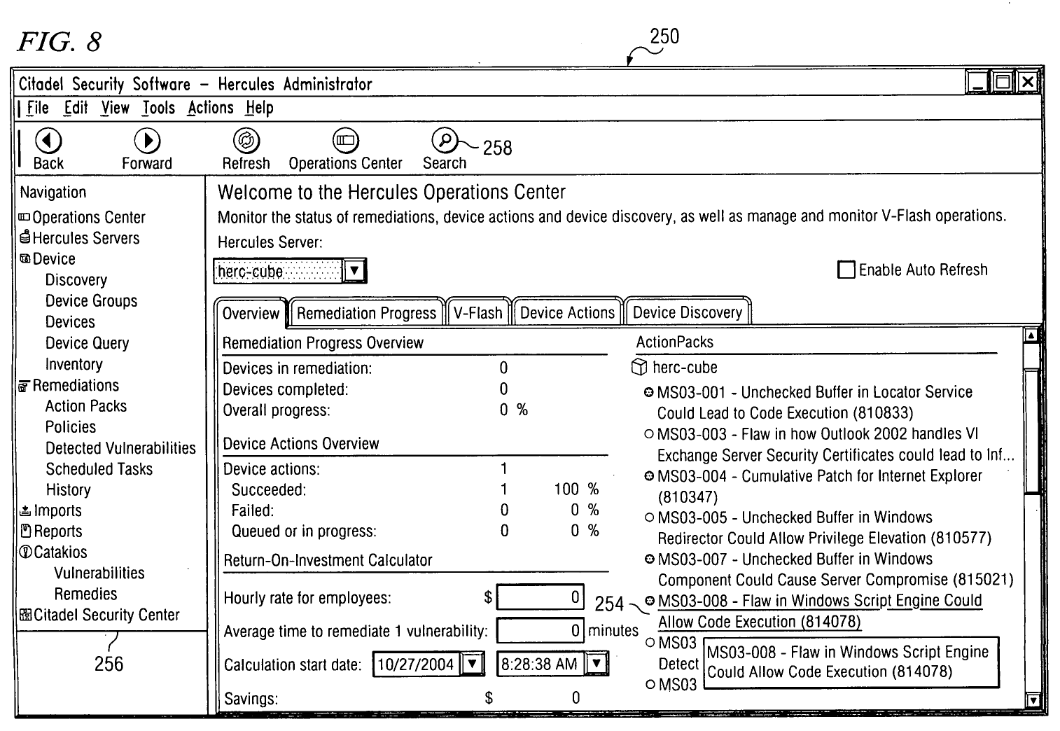

Referring next to FIG. 8, a user interface by which information may be conveyed to the network administrator will now be described in greater detail. Here, upon loading the vulnerability resolution system interface application 204 at the client administration console 25, the vulnerability resolution system interface application 204 generates a display 250 which comprises a home page for the network administrator. As will be more fully described below, by selecting one or more links which appear on the display 250, the vulnerability resolution system interface application 204 would issue an instruction to an appropriate software application.

For example, a portion 252 of the display 250 is dedicated to a list of newly downloaded action packs stored in the action pack memory location 196. By selecting a link, for example, link 254, to one of these action packs, will bring up a manage action pack page (not shown) from which the selected action pack can be executed. A second, or navigation, portion 256 of the display 250 is dedicated to a drill-down menu through which the network administrator may access other functionality residing on the client remediation server 22. For example, by selecting “servers” or “devices”, the vulnerability resolution system interface application 204 would instruct the remediation application 184 to provide access to selected portions of the remediation profiles 190 for the computer network 19 maintained in the memory subsystem 182. Similarly, by selecting “vulnerabilities” or “remediations”, the vulnerability resolution system interface application 204 would instruct the remediation application 184 to provide access to selected portions of the remediation signatures 194 maintained in the memory subsystem 182. Additionally, a search engine button 258 on the display allows the network administrator to search for assets, for example devices residing on the computer network 19. To locate a device, the network administrator would need to access the device inventory 198 maintained in the memory subsystem 182. Thus, by initiating a search, the vulnerability resolution system interface application 204 would instruct the inventory management application 183 to search the device inventory 198 for the requested device. The vulnerability resolution system interface application 204 would then generate the results of the search for review by the network administrator.

While the present invention has been illustrated and described in terms of particular apparatus and methods of use, it is apparent that equivalent parts may be substituted for those shown and other changes can be made within the scope of the present invention as defined by the appended claims. For example, in alternate embodiments thereof, it is contemplated that the present invention may be practiced without employing a central remediation server 12 and migrating the functionality disclosed herein as residing on the central remediation server 12 to the client remediation server 22. In other alternate embodiments, the client remediation server 22 could take on the role and functionality of the remediation agents 163 distributing the execution from the central remediation server 22 instead of local execution on the client computer system, for example, the portable computer system 26C. In yet other alternative embodiments, as understood by those of skill in the art, the functions between these three architecture levels may be selectively combined or migrated between components, between servers, or the components themselves combined or migrated while still providing many of the benefits of the claimed invention.

The particular embodiments disclosed herein are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claim is:

1. A method for protecting a computer network from vulnerabilities, comprising:
providing the computer network with at least one network protection module;
each of the at least one network protection modules configured to: (1) determine if one or more devices of a device type reside on the computer network; and (2) remediate each of the one or more devices of the device type based on at least one characteristic of the device type.

2. The method of claim 1, and further comprising:
executing a first one of the at least one network protection module.

3. The method of claim 2, wherein executing a first one of the at least one network protection modules further comprises:
determining if any devices of the device type reside on the computer network;
remediating each of the devices of the device type which reside on the computer network.

4. The method of claim 3, wherein determining if any devices of the device type reside on the computer network further comprises:
maintaining a device type and an inventory of devices which reside on the computer network in the network protection module and the computer network, respectively;
determining if devices of the device type reside on the computer network from the device type maintained in the network protection module and the device inventory maintained in the computer network.

5. The method of claim 4, wherein remediating each of the devices of the device type which reside on the computer network further comprises:
maintaining a remediation signature in the network protection module; and
for each device of the device type determined to reside on the computer network, remediating the device using the remediation signature.

6. The method of claim 5, wherein remediating each of the devices of the device type which reside on the computer network further comprises:
maintaining more than one remediation signature in the network protection module; and
for each device of the device type determined to reside on the computer network, using a characteristic of the device type to select between at least a first and second remediation signature and remediating the device using the selected remediation signature.

7. The method of claim 6, wherein the computer network further comprises a remediation server and wherein providing the computer network with at least one network protection module further comprises:
downloading the at least one network protection module to the remediation server.

8. The method of claim 6, wherein the computer network further comprises a remediation server and wherein providing the computer network with at least one network protection module further comprises:
constructing the at least one network protection module using remediation signatures downloaded to the remediation server.

9. A computer-readable media tangibly embodying a set of instructions executable by a computer to perform a process for resolving vulnerabilities within a computer network, comprising
means for identifying devices, residing on the computer network, having a specified vulnerability; and
means for resolving the specified vulnerability for each of the identified devices.

10. The computer-readable media of claim 9, wherein the means for identifying devices, residing on the computer network, having a specified vulnerability further comprises:
means for identifying devices, residing on the computer network, of a specified device type.

11. The computer-readable media of claim 10, wherein the means for identifying devices, residing on the computer network, having a specified vulnerability further comprises means for establishing an association between the specified device type and the specified vulnerability.

12. The computer-readable media of claim 11, wherein the means for resolving the specified vulnerability for each of the identified devices further comprises means for establishing an association between the specified vulnerability and a remediation signature.

13. The computer-readable media of claim 12, wherein the means for establishing an association between the specified vulnerability and a remediation signature for the specified vulnerability further comprises means for establishing an association between the specified device type and the remediation signature.

14. Software capable of protecting a computer network from at least one vulnerability, comprising:
a first software module which determines if devices of a specified device type reside on the computer network and remediates all devices of the specified type determined to reside on the computer network.

15. The software of claim 14, and further comprising:
a second software module which maintains an inventory of devices residing on the computer network.

16. The software of claim 15, wherein the first software module determines if any devices of the specified device type reside on the computer network by querying the inventory of devices, maintained by the second software module, for a list of all devices of the specified device type which reside on the computer network.

17. The software of claim 15, and further comprising:
a third software module which constructs the first software module by generating a query for devices of the specified device type and associates the generated query with a remediation signature.

18. The software of claim 17, wherein the third software module resides on a computer system remotely located relative to the computer network, the computer system downloading the first software module to the computer network after construction thereof.

19. A remediation server for remediating a plurality of computer systems coupled to the remediation server in a computer network, the remediation server comprising:
a processor subsystem;
a memory subsystem; and
a set of instructions stored in the memory subsystem and executable by the processor subsystem, the set of instructions resolving at least one vulnerability of devices, residing on the plurality of computer systems, of at least one device type.

20. The remediation server of claim 19, wherein the set of instructions are downloaded to the remediation server.

21. The remediation server of claim 19, wherein a device inventory is stored in the memory subsystem, the device inventory containing a list of devices residing on the plurality of computer systems.

22. The remediation server of claim 21 wherein the set of instructions further comprises a query for devices of at least one device type and wherein devices of the at least one device type which are contained in the device inventory are identified upon execution of the query.

23. The remediation server of claim 22, wherein the set of instructions further comprises a remediation signature associated with each one of the device types, the remediation signature resolving at least one vulnerability of devices of the device type associated therewith.

24. The remediation server of claim 23, wherein the set of instructions are downloaded to the remediation server.

25. The remediation server of claim 19, wherein the set of instructions further comprises: (a) a query for devices of one or more device types; (b) one or more vulnerabilities associated with each of the one or more device types; and (c) a remediation signature associated with each one of the one or more vulnerabilities.

26. The remediation server of claim 25, wherein a device inventory containing a list of devices residing on the plurality of computer systems is stored in the memory subsystem and wherein execution of the set of instructions causes the query to identifies devices, of the one or more device types, that are contained in the device inventory.

27. The remediation server of claim 26, wherein execution of the set of instructions resolves, for each device of the one or more device type, the one or more vulnerability associated with each of the one or more device type by application of the remediation signature associated with each of the one or more vulnerability to each the device of the one or more device types.

28. The remediation server of claim 27, wherein the set of instructions are downloaded to the remediation server.
